(19) United States
(12) Patent Application Publication
(10) Pub. No.: US 2026/0190018 A1
(43) Pub. Date: Jul. 2, 2026

(54) SATELLITE COMMUNICATION METHOD AND APPARATUS

(71) Applicant: HUAWEI TECHNOLOGIES CO., LTD., Shenzhen (CN)

(72) Inventors: Ruonan Yang, Shenzhen (CN); Ying Chen, Hangzhou (CN); Yunfei Qiao, Hangzhou (CN); Jun Wang, Hangzhou (CN)

(73) Assignee: HUAWEI TECHNOLOGIES CO., LTD., Shenzhen (CN)

(21) Appl. No.: 19/548,220

(22) Filed: Feb. 24, 2026

Related U.S. Application Data
(63) Continuation of application No. PCT/CN2024/114103, filed on Aug. 23, 2024.

(30) Foreign Application Priority Data
Aug. 25, 2023 (CN) 202311088837.1

(51) Int. Cl. H04W 48/16; H04L 5/00; H04W 72/231; H04W 84/06

(52) U.S. Cl. CPC H04W 48/16; H04L 5/0053; H04W 72/231; H04W 84/06

(57) ABSTRACT

A satellite communication method and an apparatus are provided, and may be applied to the field of communication technologies. The method includes: A first communication apparatus obtains decoding results in N processes, and feeds back decoding results in M processes based on the decoding results in the N processes and first configuration information. Correspondingly, a second communication apparatus obtains the decoding results fed back by the first communication apparatus, and determines the decoding results in the M processes based on the decoding results fed back by the first communication apparatus and the first configuration information. The N processes include M processes, and M is a positive integer less than or equal to N. The first configuration information indicates whether a decoding result in each of the N processes needs to be fed back.

### CROSS-REFERENCE TO RELATED APPLICATIONS

This application is a continuation of International Application No. PCT/CN2024/114103, filed on Aug. 23, 2024, which claims priority to Chinese Patent Application No. 202311088837.1, filed on Aug. 25, 2023. The disclosures of the aforementioned applications are hereby incorporated by reference in their entireties.

### TECHNICAL FIELD

This application relates to the field of communication technologies, and in particular, to a satellite communication method and an apparatus.

### BACKGROUND

With development of information technologies, more urgent requirements are imposed on high efficiency, mobility, diversity, and the like of communication. Currently, satellites are irreplaceable in some important fields, such as space communication, aviation communication, and military communication. In comparison with terrestrial mobile communication networks, satellite communication can achieve wide area or even global coverage by using high-orbit, medium-orbit and low-orbit satellites, and can provide undifferentiated communication services for global users. Satellite communication systems and the 5th generation (5G) communication systems complement each other to jointly form a global seamless sea-land-air-space integrated communication network, to meet a plurality of ubiquitous service requirements of users. This is an important development direction of future communication.

Internet of things (IoT) enables a physically independent object to implement a network connection function for information exchange and communication, to implement functions such as object identification, monitoring, positioning, and control. The IoT may be widely used in smart meter reading, precision farming, industrial automation, smart building, POS machine, environment monitoring, telemedicine, and other scenarios. Narrowband (NB)-IoT supports a repeated transmission. For example, a terminal performs hybrid automatic repeat request (HARQ) feedback based on decoding results of these repeated transmissions as a whole. In addition, the NB-IoT may further support scheduling of a plurality of transport blocks (TB) based on one piece of downlink control information (DCI). When the DCI is used to schedule a plurality of TBs, the terminal needs to feed back decoding results in these TBs.

Therefore, how the terminal feeds back the decoding results in the plurality of TBs is urgently to be resolved.

### SUMMARY

Embodiments of this application provide a satellite communication method and an apparatus, so that a first communication apparatus can appropriately and effectively feed back a decoding result in a process, to help a second communication apparatus improve link adaptation quality.

According to a first aspect, embodiments of this application provide a satellite communication method. The method is applied to a first communication apparatus. The method includes:
obtaining decoding results in N processes; and feeding back decoding results in M processes based on the decoding results in the N processes and first configuration information, where the N processes include the M processes, M is a positive integer less than or equal to N, and the first configuration information indicates whether a decoding result in each of the N processes needs to be fed back.

In embodiments of this application, the first communication apparatus may feed back the decoding results in the M processes with reference to the first configuration information and based on the decoding results in the N processes. Therefore, a manner of feeding back the decoding results by the first communication apparatus is specified, and a second communication apparatus may obtain the decoding results in the M processes, and predict channel information based on the decoding results in the M processes, thereby improving link adaptation adjustment quality.

In a possible implementation, feeding back the decoding results in the M processes based on the decoding results in the N processes and the first configuration information includes: feeding back the decoding results in the M processes on a first feedback resource based on the decoding results in the N processes and the first configuration information, where the first feedback resource is a feedback resource corresponding to i processes in the N processes, and i is less than N when M=N, or i is less than or equal to M when M is less than N.

In embodiments of this application, the first communication apparatus may feed back the decoding results in the M processes through the first feedback resource, where the first feedback resource is the feedback resource corresponding to the i processes, and i is less than or equal to M. When i is less than M, the first communication apparatus may feed back the decoding results in the M processes through feedback resources that are less than feedback resources of the M processes, so that power consumption of the first communication apparatus can be effectively reduced, and link adaptation quality of the second communication apparatus can be further improved.

In a possible implementation, the first feedback resource includes i feedback resources, an i^{th} feedback resource is used to feed back decoding results in Mᵢ processes in the M processes, and Mᵢ is an integer greater than 1 and less than M.

In a possible implementation, the first configuration information indicates that a decoding result in each of the Mᵢ processes do not need to be fed back, and feeding back the decoding results in the M processes based on the decoding results in the N processes and the first configuration information includes: sending an acknowledgement (ACK) or a negative acknowledgement (NACK) on the i^{th} feedback resource, where the ACK or the NACK is determined based on the decoding results in the Mᵢ processes.

In a possible implementation, Mᵢ=2, the Mᵢ processes include a first process and a second process, and the first configuration information indicates that the terminal device needs to feed back a decoding result in the first process and does not need to feed back a decoding result in the second process.

Feeding back the decoding results in M processes based on the decoding results in the N processes and the first configuration information includes: when the decoding result in the first process is that decoding is correct, and the decoding result in the second process is that decoding is incorrect, feeding back a negative acknowledgment NACK on a feedback resource corresponding to the second process; or when both the decoding result in the first process and the decoding result in the second process are that decoding is correct, feeding back an acknowledgment ACK on a feedback resource corresponding to the first process.

In embodiments of this application, the first communication apparatus may indicate the decoding results in the two processes on one feedback resource, to further reduce power consumption, and improve link adaptation quality of the second communication apparatus.

According to a second aspect, embodiments of this application provide a satellite communication method. The method is applied to a second communication apparatus. The method includes:
obtaining a decoding result fed back by a first communication apparatus; and determining decoding results in M processes based on the decoding result fed back by the first communication apparatus and first configuration information, where the first configuration information indicates whether the terminal device needs to feed back a decoding result in each of N processes, N is an integer greater than or equal to 2, the N processes include the M processes, and M is an integer less than or equal to N.

In a possible implementation, determining the decoding results in the M processes based on the decoding result fed back by the first communication apparatus and the first configuration information includes:
determining the decoding results in the M processes based on the decoding result fed back by the terminal device, the first configuration information, and a first feedback resource, where the first feedback resource is a feedback resource corresponding to i processes in the N processes, and i is less than N when M=N, or i is less than or equal to M when M is less than N.

In a possible implementation, the first feedback resource includes i feedback resources, an i^{th} feedback resource is used to feed back decoding results in Mᵢ processes in the M processes, and Mᵢ is an integer greater than 1 and less than M.

In a possible implementation, the first configuration information indicates that a decoding result in each of the Mᵢ processes does not need to be fed back, and determining the decoding results in the M processes based on the decoding result fed back by the terminal device and the first configuration information includes:
receiving an acknowledgment ACK or a negative acknowledgment NACK on the i^{th} feedback resource, where the ACK or the NACK is determined based on the decoding results in the Mᵢ processes; and determining the decoding results in the M processes based on the i^{th} feedback resource and the ACK or the NACK.

In a possible implementation, Mᵢ=2, the Mᵢ processes include a first process and a second process, and the first configuration information indicates that the terminal device needs to feed back a decoding result in the first process and does not need to feed back a decoding result in the second process.

Determining the decoding results in the M processes based on the decoding result fed back by the terminal device and the first configuration information includes:
determining, based on the first configuration information and a NACK received on a feedback resource corresponding to the second process, that the decoding result in the first process is that decoding is correct, and the decoding result in the second process is that decoding is incorrect; or determining, based on the first configuration information and an ACK received on a feedback resource corresponding to the first process, that both the decoding result in the first process and the decoding result in the second process are that decoding is correct.

In the foregoing implementations, the first communication apparatus may be a terminal device, a chip or a functional module used in a terminal device, or the like, and the second communication apparatus may be a network device, a chip or a functional module used in a network device, or the like. Alternatively, the first communication apparatus may be a network device, a chip or a functional module used in a network device, or the like, and the second communication apparatus may be a terminal device, a chip or a functional module used in a terminal device, or the like. Alternatively, the first communication apparatus and the second communication apparatus may be different terminal devices, chips, or functional modules.

With reference to the first aspect or the second aspect, in a possible implementation, the method further includes: The terminal device receives the first configuration information.

With reference to the first aspect or the second aspect, in a possible implementation, the method further includes: The network device sends the first configuration information.

With reference to the first aspect or the second aspect, in a possible implementation, the method further includes: The terminal device receives second configuration information, where the second configuration information is used to configure a first function for the terminal device, and the first function indicates that the terminal device is allowed to feed back the decoding results in the M processes based on the decoding results in the N processes and the first configuration information.

With reference to the first aspect or the second aspect, in a possible implementation, the method further includes: The network device sends second configuration information, where the second configuration information is used to configure a first function for the terminal device, and the first function indicates that the terminal device is allowed to feed back the decoding results in the M processes based on the decoding results in the N processes and the first configuration information.

With reference to the first aspect or the second aspect, in a possible implementation method, that the terminal device receives the first configuration information includes:

The terminal device receives the first configuration information and second configuration information, where the second configuration information is used to configure a first function for the terminal device, and the first function indicates that the terminal device is allowed to feed back the decoding results in the M processes based on the decoding results in the N processes and the first configuration information.

With reference to the first aspect or the second aspect, in a possible implementation, that the network device sends the first configuration information includes:

The network device sends the first configuration information and second configuration information, where the second configuration information is used to configure a first function for the terminal device, and the first function indicates that the terminal device is allowed to feed back the decoding results in the M processes based on decoding results in the N processes and the first configuration information.

With reference to the first aspect or the second aspect, in a possible implementation, the method further includes: The terminal device receives activation information, where the activation information is used to activate the first function.

With reference to the first aspect or the second aspect, in a possible implementation, the method further includes: The network device sends activation information, where the activation information is used to activate the first function.

With reference to the first aspect or the second aspect, in a possible implementation, the activation information includes DCI or a medium access control (MAC) control element (CE); or the activation information indicates a periodicity T, and the periodicity T is an effective periodicity of the first function.

With reference to the first aspect or the second aspect, in a possible implementation, when a MAC CE is received on at least one of the N processes, the first function is indicated to be activated.

With reference to the first aspect or the second aspect, in a possible implementation, the first configuration information includes a bitmap, each bit in the bitmap corresponds to one process, and a value of the bit indicates whether the terminal device needs to feed back a decoding result in the corresponding process.

According to a third aspect, an embodiment of this application provides a first communication apparatus configured to perform the method according to any one of the first aspect or the possible implementations of the first aspect. The first communication apparatus includes a unit that performs the method according to any one of the first aspect or the possible implementations of the first aspect.

According to a fourth aspect, an embodiment of this application provides a second communication apparatus configured to perform the method according to any one of the second aspect or the possible implementations of the second aspect. The second communication apparatus includes a unit that performs the method according to any one of the second aspect or the possible implementations of the second aspect.

According to a fifth aspect, an embodiment of this application provides a first communication apparatus. The first communication apparatus includes a processor configured to perform the method according to any one of the first aspect or the possible implementations of the first aspect. Alternatively, the processor is configured to execute a program stored in a memory. When the program is executed, the method according to any one of the first aspect or the possible implementations of the first aspect is performed.

In a possible implementation, the memory is located outside the first communication apparatus.

In a possible implementation, the memory is located inside the first communication apparatus.

In embodiments of this application, the processor and the memory may alternatively be integrated into one device. In other words, the processor and the memory may alternatively be integrated. For example, the first communication apparatus may be a chip.

In a possible implementation, the first communication apparatus further includes a transceiver. The transceiver is configured to receive a signal or send a signal.

According to a sixth aspect, an embodiment of this application provides a second communication apparatus. The second communication apparatus includes a processor configured to perform the method according to any one of the second aspect or the possible implementations of the second aspect. Alternatively, the processor is configured to execute a program stored in a memory. When the program is executed, the method according to any one of the second aspect or the possible implementations of the second aspect is performed.

In a possible implementation, the memory is located outside the second communication apparatus.

In a possible implementation, the memory is located inside the second communication apparatus.

In embodiments of this application, the processor and the memory may alternatively be integrated into one device. In other words, the processor and the memory may alternatively be integrated. For example, the second communication apparatus may be a chip.

In a possible implementation, the second communication apparatus further includes a transceiver. The transceiver is configured to receive a signal or send a signal.

According to a seventh aspect, an embodiment of this application provides a first communication apparatus. The first communication apparatus includes a logic circuit and an interface. The logic circuit is coupled to the interface. The interface is configured to input and/or output information. The logic circuit is configured to perform the method according to any one of the first aspect or the possible implementations of the first aspect.

According to an eighth aspect, an embodiment of this application provides a second communication apparatus. The second communication apparatus includes a logic circuit and an interface. The logic circuit is coupled to the interface. The interface is configured to input and/or output information. The logic circuit is configured to perform the method according to any one of the second aspect or the possible implementations of the second aspect.

According to a ninth aspect, an embodiment of this application provides a computer-readable storage medium. The computer-readable storage medium is configured to store a computer program, and when the computer program is run on a computer, the method according to any one of the first aspect, the second aspect, or the possible implementations of the first aspect and the second aspect is performed.

According to a tenth aspect, an embodiment of this application provides a computer program product. The computer program product includes a computer program or computer code, and when the computer program or the computer code is run on a computer, the method according to any one of the first aspect, the second aspect, or the possible implementations of the first aspect and the second aspect is performed.

According to an eleventh aspect, an embodiment of this application provides a computer program. When the computer program is run on a computer, the method according to any one of the first aspect, the second aspect, or the possible implementations of the first aspect and the second aspect is performed.

According to a twelfth aspect, an embodiment of this application provides a communication system. The communication system includes a first communication apparatus and a second communication apparatus, the first communication apparatus is configured to perform the method according to any one of the first aspect or the possible implementations of the first aspect, and the second communication apparatus is configured to perform the method according to any one of the second aspect or the possible implementations of the second aspect.

### BRIEF DESCRIPTION OF DRAWINGS

FIG. 1 is a diagram of an architecture of a communication system according to an embodiment of this application;

FIG. 2a is a diagram of a satellite communication system in a transparent transmission scenario according to an embodiment of this application;

FIG. 2b is a diagram of a satellite communication system in a regeneration scenario according to an embodiment of this application;

FIG. 2c is a diagram of another satellite communication system in a regeneration scenario according to an embodiment of this application;

FIG. 3 is a schematic flowchart of a satellite communication method according to an embodiment of this application;

FIG. 4 is a diagram of effective time of a periodicity T according to an embodiment of this application;

FIG. 5 is a diagram of activating an enhanced mode based on activation DCI according to an embodiment of this application;

FIG. 6a is a diagram of feedback when an enhanced mode is not enabled according to an embodiment of this application;

FIG. 6b is a diagram of feedback when an enhanced mode is enabled according to an embodiment of this application;

FIG. 7a is a diagram of feedback when an enhanced mode is not enabled according to an embodiment of this application;

FIG. 7b is a diagram of feedback when an enhanced mode is enabled according to an embodiment of this application;

FIG. 8 is a schematic flowchart of another satellite communication method according to an embodiment of this application;

FIG. 9 is a diagram of a structure of a communication apparatus according to an embodiment of this application;

FIG. 10 is a diagram of a structure of another communication apparatus according to an embodiment of this application; and

FIG. 11 is a diagram of a structure of still another communication apparatus according to an embodiment of this application.

### DESCRIPTION OF EMBODIMENTS

For ease of understanding technical solutions of this application, the following further describes this application with reference to accompanying drawings.

Terms “first”, “second”, and the like in the specification, claims, and accompanying drawings of this application are merely used to distinguish between different objects, and are not used to describe a specific order. In addition, the terms “include”, “have”, or any other variant thereof are intended to cover a non-exclusive inclusion. For example, a process, a method, a system, a product, or a device that includes a series of operations or units is not limited to the enumerated operations or units, but, in some embodiments further includes an unenumerated operation or unit, or, in various embodiments further includes another operation or unit inherent to the process, the method, the product, or the device.

An “embodiment” mentioned in this specification means that a particular feature, structure, or characteristic described with reference to the embodiment may be included in at least one embodiment of this application. The phrase shown in various locations in the specification may not necessarily indicate a same embodiment, and is not an independent or optional embodiment exclusive from another embodiment. It is explicitly and implicitly understood by a person skilled in the art that embodiments described in the specification may be combined with another embodiment.

In this application, “at least one (item)” means one or more, “a plurality of” means two or more, “at least two (items)” means two, three, or more, and “and/or” is used to describe an association relationship between associated objects, and indicates that three relationships may exist. For example, “A and/or B” may indicate that only A exists, only B exists, and both A and B exist, where A and B may be singular or plural. “Or” indicates that two relationships may exist, for example, only A exists and only B exists. When A and B are not mutually exclusive, it may indicate that three relationships exist, for example, only A exists, only B exists, and both A and B exist. The character “/” generally indicates an “or” relationship between associated objects. “At least one of the following” or a similar expression thereof means any combination of these items. For example, at least one of a, b, or c may represent: a, b, c, “a and b”, “a and c”, “b and c”, or “a and b and c”.

A method provided in embodiments of this application may be applied to a non-terrestrial network (NTN) communication system. As shown in FIG. 1, the communication system may include a terminal device, a satellite, and a terrestrial station (which may also be referred to as a gateway or a gateway station). FIG. 1 shows only one satellite and one terrestrial station. In actual use, an architecture with a plurality of satellites and/or a plurality of terrestrial stations may be used as required. Each satellite may provide a service for one or more terminal devices, each satellite may correspond to one or more terrestrial stations, each terrestrial station may correspond to one or more satellites, or the like. This is not specifically limited in embodiments of this application. The method provided in embodiments of this application may be applied to an internet of things (IoT) system, a vehicle to everything (Vehicle to X, V2X) system, and a narrowband internet of things (NB-IoT) system. For another example, the method may be applied to an LTE frequency division duplex (FDD) system, an LTE time division duplex (TDD) system, a long term evolution (LTE) system, a 5th generation (5G) communication system, a 6th generation (6G) communication system, a future communication system, or the like. This is not specifically limited in embodiments of this application.

The terminal device is an apparatus having a wireless transceiver function. The terminal device may communicate with an access network device (or referred to as an access device) in a radio access network (RAN). The terminal device may also be referred to as user equipment (UE), an access terminal, a terminal, a subscriber unit, a subscriber station, a mobile station, a remote station, a remote terminal, a mobile device, a user terminal, a user agent, a user apparatus, or the like. In a possible implementation, the terminal device may be deployed on land, including an indoor or outdoor terminal device, and a handheld or vehicle-mounted terminal device; or may be deployed on water (for example, on a ship). In a possible implementation, the terminal device may be a handheld device, a vehicle-mounted device, a wearable device, a sensor, a terminal in an internet of things, a terminal in an internet of vehicles, an uncrewed aerial vehicle, a terminal device in any form in a 5th generation (5G) network or a future network, or the like that has a wireless communication function. This is not limited in embodiments of this application. For example, communication may further be performed between terminal devices by using device-to-device (D2D) or machine-to-machine (M2M). The terminal device shown in embodiments of this application may alternatively be a device in the internet of things (IoT). This IoT network may include, for example, the internet of vehicles. Communication manners in the internet of vehicles system are collectively referred to as a vehicle to X (V2X, where X may represent anything). For example, the V2X may include vehicle-to-vehicle (V2V) communication, vehicle-to-infrastructure (V2I) communication, vehicle-to-pedestrian (V2P) communication, vehicle-to-network (V2N) communication, or the like.

The terrestrial station may be configured to connect a satellite to a base station, or a satellite to a core network. The satellite may provide a radio access service to a terminal device, schedule a radio resource to an accessed terminal device, and provide a reliable radio transmission protocol, a data encryption protocol, and the like. In an example, the satellite may be an artificial earth satellite, a high-altitude aircraft, or the like that is used as a wireless communication base station, for example, an evolved NodeB (eNB) and a next generation NodeB (gNB). In another example, the satellite may alternatively serve as a relay of these base stations, and transparently transmit signals of these base stations to the terminal device.

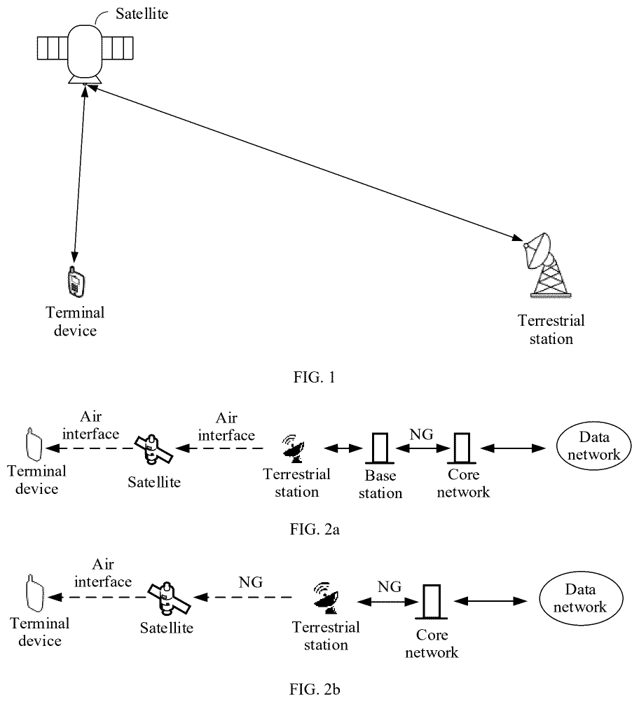

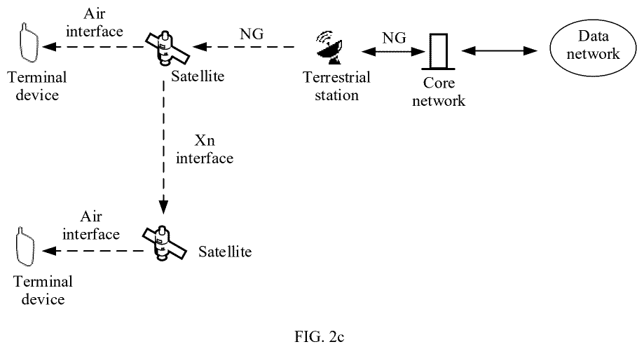

Therefore, in some implementations of this application, for example, in a satellite transparent transmission scenario, a network device may be the base station (which may also be referred to as a ground base station) shown in FIG. 1. FIG. 2a is a diagram of a satellite communication system in a transparent transmission scenario according to an embodiment of this application. For example, a terminal device may access a network through an air interface (where the air interface may be various types of air interfaces, for example, a 5G air interface), and a network device may be deployed on a ground base station. A satellite is connected to a terrestrial station through a radio link. The terrestrial station and the ground base station are connected to a core network in a wired or wireless manner. A radio link may exist between satellites. In the system shown in FIG. 2a, the satellite may have a transparent transmission and forwarding function. In some other implementations of this application, for example, in a regeneration scenario of the satellite, the network device may be the satellite shown in FIG. 1. FIG. 2b is a diagram of a satellite communication system in a regeneration scenario according to an embodiment of this application. For example, a terminal device may access a network through an air interface (where the air interface may be various types of air interfaces, for example, a 5G air interface), and a network device may be deployed on a satellite (for example, in a regeneration mode of the satellite). For example, a base station or some functions of the base station are deployed on the satellite, and signaling exchange and a user data transmission between base stations may be completed between satellites, as shown in FIG. 2c.

For example, network elements and interfaces between the network elements in FIG. 2a to FIG. 2c may be shown below.

The terminal device may access a satellite network through the air interface and initiates services such as calls and internet access. The base station may be configured to provide a radio access service, schedule a radio resource to an access terminal device, and provide a reliable radio transmission protocol, a data encryption protocol, and the like. The terrestrial station may be configured to be responsible for forwarding signaling and service data between the satellite and the core network. The core network may be configured for user access control, mobility management, session management, user security authentication, charging, or the like. The core network may include a plurality of functional units, for example, functional entities including a control plane and a data plane. For example, the core network shown in FIG. 2a to FIG. 2c may include an access and mobility management function (AMF), a session management function (SMF), a user plane function (UPF), and the like. For example, the AMF may be configured to be responsible for user access management, security authentication, mobility management, and the like. The UPF may be configured to be responsible for managing a user plane data transmission, traffic statistics collection, and the like. The air interface shown in FIG. 2a to FIG. 2c may be understood as a radio link between a terminal and the base station, or a radio link between the satellite and the terrestrial station. An Xn interface may be understood as an interface between base stations, and is mainly configured to exchange signaling such as handover. An NG interface may be used as an interface between the base station and the core network, and is configured to exchange signaling such as non-access stratum (NAS) signaling of the core network and service data of a user. In systems using different radio access technologies, names of devices having a base station function may be different, and are not shown one by one in embodiments of this application.

The satellite may be a geostationary earth orbit (GEO) satellite, a medium earth orbit (MEO) satellite or a low earth orbit (LEO) satellite in a non-geostationary earth orbit (NGEO), a high altitude platform station (HAPS), or the like. A type of the satellite is not limited in embodiments of this application.

In some deployments of the network device, the network device may include a central unit (CU) and a distributed unit (DU). In some other deployments of the network device, the CU may be further divided into a CU-control plane (CP) and a CU-user plane (UP). In still some other deployments of the network device, the network device may alternatively be of an open radio access network (ORAN) architecture or the like. A deployment manner of the network device is not limited in embodiments of this application. For example, when the network device is of the ORAN architecture, the network device shown in embodiments of this application may be an access network device, a functional module, or the like in an ORAN. In an ORAN system, a CU may also be referred to as an open (O)-CU, a DU may also be referred to as an O-DU, a CU-CP may also be referred to as an O-CU-CP, a CU-UP may also be referred to as an O-CU-UP, and the like. The deployment manner of the network device enumerated herein is merely an example. With evolution of a standard technology, the network device may have another deployment manner.

The network architecture and the service scenario described in embodiments of this application are intended to describe the technical solutions in embodiments of this application more clearly, and do not constitute a limitation on the technical solutions provided in embodiments of this application. A person of ordinary skill in the art may know that with evolution of the network architecture and the emergence of new service scenarios, the technical solutions and the network architecture provided in embodiments of this application are also applicable to similar technical problems.

The following describes terms used in embodiments of this application.

### 1. Hybrid Automatic Repeat Request (HARQ)

HARQ is a method for improving data transmission reliability. The method may be shown as follows: For example, a data packet with a decoding error is stored in a HARQ buffer, and the data packet with the decoding error is combined with a retransmitted data packet that is subsequently received, to obtain a data packet that is more reliable than that obtained through separate decoding (a “soft combination” process). Then, a combined data packet is decoded. If decoding still fails, “requesting a retransmission and then performing soft combination” are repeated.

For the HARQ, whether an error occurs in a received data packet may be determined through a cyclic redundancy check (CRC). A CRC check operation may be performed after the soft combination. If a CRC check succeeds, a receive end may send an acknowledgment (ACK). If the CRC check fails, the receive end may send a negative acknowledgment (NACK). For example, a transmit end shown in embodiments of this application may include a network device, and the receive end may include a terminal device. Alternatively, the transmit end may include a terminal device, and the receive end includes a network device. Alternatively, both the transmit end and the receive end may be terminal devices.

### 2. Stop-and-Wait Protocol

A transmit end may send data according to the stop-and-wait protocol. According to the stop-and-wait protocol, after sending a transport block (TB), the transmit end stops to wait for feedback information. A receive end may use 1-bit information to feed back an ACK or a NACK for the TB. However, after each TB transmission, the transmit end stops to wait for feedback information, resulting in a low throughput. Therefore, when the transmit end waits for feedback information through a plurality of parallel HARQ processes, the transmit end may continue to send data through another HARQ process, so that data can be continuously transmitted. Each HARQ process may correspond to an independent HARQ buffer, so that the receive end can perform soft combination on received data.

### 3. HARQ Feedback Disabling

HARQ feedback disabling indicates that ACKs or NACKs in some processes may be configured not to be fed back. For example, when a network device schedules a plurality of TBs based on DCI (or referred to as scheduling DCI), and one TB corresponds to one process, the plurality of TBs may correspond to a plurality of processes. The network device may configure, through HARQ feedback disabling, that a decoding result in at least one of the plurality of processes does not need to be fed back.

For example, a process in which a decoding result does not need to be fed back may also be referred to as a process in which HARQ feedback is disabled, and a process in which a decoding result needs to be fed back may also be referred to as a process in which HARQ feedback is enabled. HARQ feedback disabling may also be referred to as HARQ feedback deactivation or the like. A name of HARQ feedback disabling is not limited in embodiments of this application.

### 4. Relationship Between a TB and a Process

Generally, one transport block may correspond to one process. However, when the transport block is divided into a plurality of code blocks, one code block may correspond to one process, and therefore one transport block may correspond to a plurality of processes. The relationship between a transport block and a process is not limited in embodiments of this application. For ease of description, the following uses an example in which one transport block corresponds to one process to describe the method provided in embodiments of this application.

Embodiments of this application provide a satellite communication method and an apparatus. According to the method, a first communication apparatus can appropriately and effectively feed back a decoding result in a process, to help a second communication apparatus improve link adaptation quality. For example, the method may further effectively reduce power consumption of the first communication apparatus. The method shown in embodiments of this application may be applied to an NTN, for example, an IoT NTN, an NB-IoT, an NR NTN, an eMTC, or an eMTC NTN. Examples are not enumerated one by one herein.

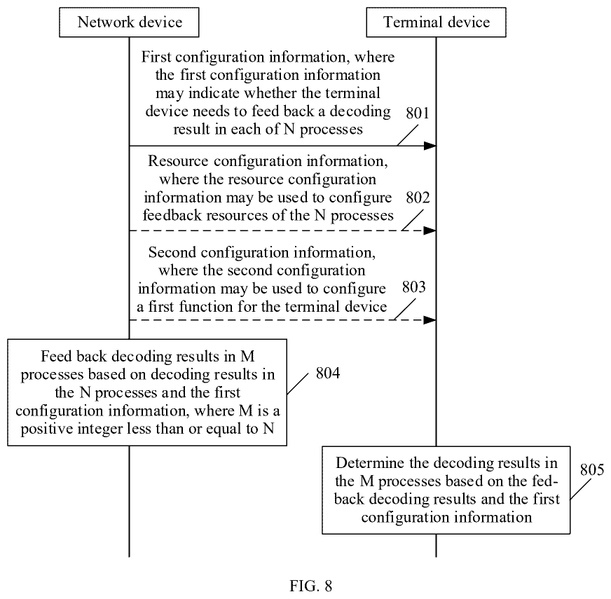

FIG. 3 is a schematic flowchart of a satellite communication method according to an embodiment of this application. FIG. 3 is shown by using an example in which the first communication apparatus is a terminal device and the second communication apparatus is a network device. FIG. 8 is shown by using an example in which the first communication apparatus is a network device and the second communication apparatus is a terminal device. As shown in FIG. 3, the method includes the following operations.
301: The network device sends first configuration information, and correspondingly, the terminal device receives the first configuration information.

The first configuration information may indicate whether the terminal device needs to feed back a decoding result in each of N processes. For another example, the first configuration information may indicate whether a decoding result in each of N processes needs to be fed back. For another example, the first configuration information may be used to configure HARQ feedback disabling. For another example, the first configuration information may indicate that a decoding result in a part of the N processes needs to be fed back (or referred to as a process in which HARQ feedback is enabled or referred to as an enabling process), and a decoding result in the other part of the N processes do not need to be fed back (or referred to as a process in which HARQ feedback is disabled or referred to as a disabling process). For another example, the first configuration information may indicate that a decoding result in each of the N processes does not need to be fed back. Here, N may be an integer greater than or equal to 2.

In embodiments of this application, based on the first configuration information, decoding results in some processes are configured not to be fed back. Therefore, after sending a TB scheduled this time, the network device may schedule a new TB through the foregoing processes. This reduces an ACK/NACK transmission latency and effectively improve a throughput.

The decoding result is a result of whether the terminal device performs decoding correctly (or whether decoding is correct, or whether a CRC check is correct), and includes an ACK or a NACK. For example, that a decoding result in a process #1 needs to be fed back indicates that the terminal device may feed back an ACK or a NACK for a TB corresponding to the process #1. That a decoding result in a process #2 does not need to be fed back indicates that the terminal device does not need to feed back an ACK or a NACK regardless of whether the terminal device performs decoding correctly.

TBs corresponding to the N processes may be scheduled based on one piece of DCI (for example, scheduling DCI in operation 302 below). For example, the scheduling DCI includes a number of scheduled TB for unicast (number of scheduled TB for unicast) field. If a value of the field is 1, it indicates that a plurality of TBs are scheduled. The scheduling DCI may be DCI scrambled based on a cell-radio network temporary identifier (C-RNTI). For example, in the first configuration information, HARQ feedback disabling of N TBs scheduled based on one piece of DCI may be configured. For example, the network device may configure, in a bitmap manner, whether a decoding result in each process needs to be fed back. For example, the first configuration information may include a bitmap, and each bit in the bitmap may correspond to one process. A value of the bit indicates whether the terminal device feeds back a decoding result in the corresponding process. The bitmap may occupy N bits, and the bitmap may indicate whether an ACK or a NACK in each of the N processes needs to be fed back.

For example, the first configuration information may indicate whether a decoding result in each of Nₘₐₓ processes needs to be fed back. The Nₘₐₓ processes include the N processes. For example, the bitmap may occupy Nₘₐₓ bits. For example, Nₘₐₓ may be a maximum quantity of processes supported by the terminal device. For example, for a new radio (NR) NTN, a maximum quantity of processes scheduled based on one piece of DCI may be 32. Increasing the maximum quantity of processes in the NR NTN can effectively reduce a throughput loss caused by a round-trip latency, and increase a throughput. For example, for narrowband (NB)-IoT, a maximum quantity of processes scheduled based on one piece of DCI may be 2. For example, for an enhanced machine type communication (eMTC) mode A, a maximum quantity of processes scheduled based on one piece of DCI may be 8. The foregoing maximum quantity of processes is merely an example. With development of a standard, the foregoing maximum quantity of processes may increase. This is not limited in embodiments of this application.

In an example, the first configuration information may be carried in RRC signaling. In another example, the first configuration information may be carried in a MAC CE. In still another example, the first configuration information may be carried in DCI. For example, the first configuration information may be carried in scheduling DCI. The network device may carry the first configuration information in scheduling DCI. When the first configuration information changes, the first configuration information may be carried in scheduling DCI again.

For example, the first configuration information configured by the network device may be at a UE level. For example, the network device may configure different bitmaps for different UEs. Certainly, there may be a case in which the network device configures a same bitmap for some UEs. This is not limited in embodiments of this application. A manner in which the network device configures the bitmap is not limited in embodiments of this application. For example, the network device may configure, randomly or based on a specific implementation, that decoding results in some processes do not need to be fed back by the terminal device, and configure that decoding results in some other processes need to be fed back by the terminal device.

In a possible implementation, the method shown in FIG. 3 may further include operation 302.
302: The network device sends resource configuration information, and correspondingly, the terminal device receives the resource configuration information. The resource configuration information may be used to configure feedback resources of the N processes. The feedback resources may be used by the terminal device to feed back decoding results in the N processes. For example, one feedback resource may be a feedback data length of one TB.

The resource configuration information may be carried in DCI, and the DCI may be referred to as scheduling DCI. The resource configuration information may be a HARQ ACK resource field in the scheduling DCI. The HARQ ACK resource field in the scheduling DCI may be used to configure (or indicate) a feedback resource for the terminal device, or configure a start location of the feedback resource, or configure a start location of a time domain resource in the feedback resource. For example, the HARQ ACK resource field may indicate K₀, K₀ may be used to determine the start location of the feedback resource, and the start location may be a latency K relative to data receiving, for example, K=K₀+K_{offset}−1. For ease of description, the following describes the method provided in embodiments of this application by using an example in which the HARQ ACK resource field indicates the latency K. With development of the standard, a manner of calculating the latency K may change. This is not limited in embodiments of this application.

A start location of a feedback resource of a 1^{st} process in the N processes may be determined based on K₀ indicated by the HARQ ACK resource field, a start location of a feedback resource of a process other than the 1^{st} process in the N processes may be determined based on the HARQ ACK resource field, a subcarrier spacing, and a quantity of HARQ feedback repetitions. The terminal device may effectively learn of the start location of the feedback resource of the 1^{st} process in the N processes based on the HARQ ACK resource field, and learn of the start location of the feedback resource of the process other than the 1^{st} process in the N processes based on the subcarrier spacing and the quantity of HARQ feedback repetitions. A length of a time domain resource occupied by a feedback resource of each of the N processes may be M*Nrep time resource units, and feedback resources corresponding to the N processes may be consecutive. A value of M is related to the subcarrier spacing, and Nᵣₑₚ indicates the quantity of HARQ feedback repetitions. A value of Nᵣₑₚ may be configured by the network device based on RRC signaling. For example, the network device may configure both the value of Nᵣₑₚ and the first configuration information for the terminal device. For example, the subcarrier spacing is 15 kHz, and M=2. For another example, the subcarrier spacing is 3.75 kHz, and M=8. The time resource unit may be a subframe, a slot, or the like. This is not limited in embodiments of this application.

For example, a feedback time domain resource of the 1^{st} process may start from a time resource unit of K₀+K_{offset}−1 after data receiving ends, and occupy M*Nᵣₑₚ time resource units. Feedback resources of the N processes are sequentially consecutive. For example, when M=2, Nᵣₑₚ=3, and the time resource unit is a subframe, a feedback resource of the 1^{st} process starts from a subframe whose subframe number is K₀+K_{offset}−1 after the terminal device receives data, and occupies six subframes. A feedback resource of a 2^{nd} process occupies six subframes from an end location of the feedback resource of the 1^{st} process, a feedback resource of a 3^{rd} process occupies six subframes from an end location of the feedback resource of the 2^{nd} process, and the like. A feedback resource corresponding to each of the N processes in embodiments of this application may also be considered that one process may correspond to one feedback resource and the N processes correspond to N feedback resources.

In embodiments of this application, the scheduling DCI may indicate the feedback resource corresponding to each of the N processes (or referred to as the feedback resource of the process) (for example, K₀ shown above and/or a frequency domain resource), used to schedule the N TBs, indicate a time-frequency resource used by the terminal device to receive a TB, a modulation and coding scheme (MCS), and the like. Another function of the scheduling DCI is not limited in embodiments of this application. For example, the scheduling DCI may further include information about a periodicity T, as shown in the following implementation 2.

In a possible implementation, it is considered by default that the terminal device supports a first function. In other words, the terminal device may perform operation 304 in the following by default.

For example, the first function indicates that the terminal device is allowed to feed back decoding results in M processes based on the decoding result in the process and the first configuration information. For another example, the first function indicates that the terminal device can feed back decoding results in M processes based on the decoding result in the process and the first configuration information. For another example, the first function indicates that the terminal device is allowed to feed back the decoding result based on the first configuration information, or based on the decoding results in the N processes, or based on the decoding results in the N processes and a first feedback resource. The first function is relative to the terminal device feeding back the decoding result in the process based on the first configuration information.

When the terminal device supports the first function by default, the network device may send first function failure information, and the terminal device receives the first function failure information, and may not perform, based on the first function failure information, feedback that is based on operation 304 shown in embodiments of this application. For example, the terminal device does not perform, based on the first function failure information, feedback that is of the decoding results in the M processes and that is based on the decoding results in the N processes and the first configuration information, but performs feedback based on the first configuration information.

For example, the first function may be referred to as enhanced multiple process scheduling enable, enhanced multiple TB scheduling enable, an enhanced mode, or the like.

In another possible implementation, operation 301 includes: The network device sends first configuration information and second configuration information, and correspondingly, the terminal device receives the first configuration information and the second configuration information. For example, the network device may configure the first configuration information and the second configuration information for the terminal device based on RRC signaling. For related descriptions of the second configuration information, refer to the descriptions of operation 303. Details are not described herein.

In still another possible implementation, operation 302 includes: The network device sends scheduling DCI, and correspondingly, the terminal device receives the scheduling DCI. The scheduling DCI includes a HARQ ACK resource field and the second configuration information. For related descriptions of the second configuration information, refer to the descriptions of operation 303. Details are not described herein.

In still another possible implementation, the method shown in FIG. 3 may further include operation 303.
303: The network device sends the second configuration information, and correspondingly, the terminal device receives the second configuration information.

The second configuration information may be used to configure the first function for the terminal device. When the network device configures the first function for the terminal device, the terminal device may perform feedback based on the decoding result in the process and the first configuration information, or the terminal device has a capability of performing feedback based on the first configuration information and the decoding result in the process. For another example, the terminal device may perform feedback based on the first configuration information and a HARQ process feedback configured based on the scheduling DCI (as shown in operation 304 below). For example, the HARQ process feedback configured based on the DCI may be used to reverse the first configuration information. When the network device does not configure the first function for the terminal device, for example, the terminal device may perform feedback based on the first configuration information. For example, the first function may be configured by the network device based on RRC signaling or scheduling DCI. The scheduling DCI may be scheduling DCI before the scheduling DCI used to schedule the TBs corresponding to the N processes. In other words, before this scheduling DCI, the network device may configure the first function based on scheduling DCI for scheduling another TB.

In a possible implementation, the network device configures the first function for the terminal device, and the first function is activated by default.

In another possible implementation, after the network device configures the first function for the terminal device, the first function further needs to be activated. After the first function is activated, the terminal device may feed back the decoding results based on the decoding result in the process and the first configuration information. When the first function is not activated, even if the first function is configured for the terminal device, the terminal device still cannot feed back the decoding results based on the decoding result in the process and the first configuration information.

For example, the first function may be activated in the following implementation:

### Implementation 1

The network device sends activation information, and correspondingly, the terminal device receives the activation information. The activation information may be used to activate the first function. Alternatively, the activation information may be used to activate a function configured by the network device for the terminal device based on the second configuration information. Alternatively, the activation information may be used to activate the terminal device to perform operation 304.

For example, the activation information includes DCI or a MAC CE. For example, the activation information may be referred to as activation DCI or an activation MAC CE. For example, the activation DCI may include one bit indicating whether to activate the first function. A value of the bit being 1 indicates to activate the first function. The value of the bit being 0 indicates to deactivate the first function. Other information in the activation DCI is not limited in embodiments of this application. For example, the activation DCI and the scheduling DCI may be different DCI.

In the implementation 1, the network device may further send deactivation information, and correspondingly, the terminal device receives the deactivation information. The deactivation information may be used to deactivate the first function. Alternatively, the deactivation information may be used to deactivate a function configured by the network device for the terminal device based on the second configuration information. When performing HARQ feedback based on the deactivation information, the terminal device may not perform feedback according to the method shown in operation 304 below. Time from the terminal device receiving the activation information to the terminal device receiving the deactivation information may be effective time of the first function.

In embodiments of this application, the first function is activated based on the activation information, and the first function is deactivated based on the deactivation information. This is simple and efficient, so that the terminal device can clearly learn whether the terminal device can perform the first function.

### Implementation 2

In an example, activation information may be carried in the scheduling DCI. For example, the scheduling DCI may include information about the periodicity T, and the periodicity T is an effective periodicity of the first function. For other descriptions of the activation information, refer to the implementation 1. Details are not described herein again.

In an example, the scheduling DCI may include a value of the periodicity T. In another example, the network device may configure one or more periodicities, for example, configure one or more periodicities based on RRC signaling, and each periodicity may correspond to one index. The scheduling DCI may include an index of the periodicity T. In still another example, when the network device configures one periodicity, the scheduling DCI may not include information about the periodicity T, and the terminal device implicitly indicates that the periodicity T takes effect when receiving the scheduling DCI, or the terminal device implicitly indicates that a periodicity T (another periodicity T relative to the foregoing periodicity T) takes effect when receiving the scheduling DCI for the first time beyond duration of the periodicity T. The related descriptions about the periodicity T taking effect are applicable to the three examples shown in this section.

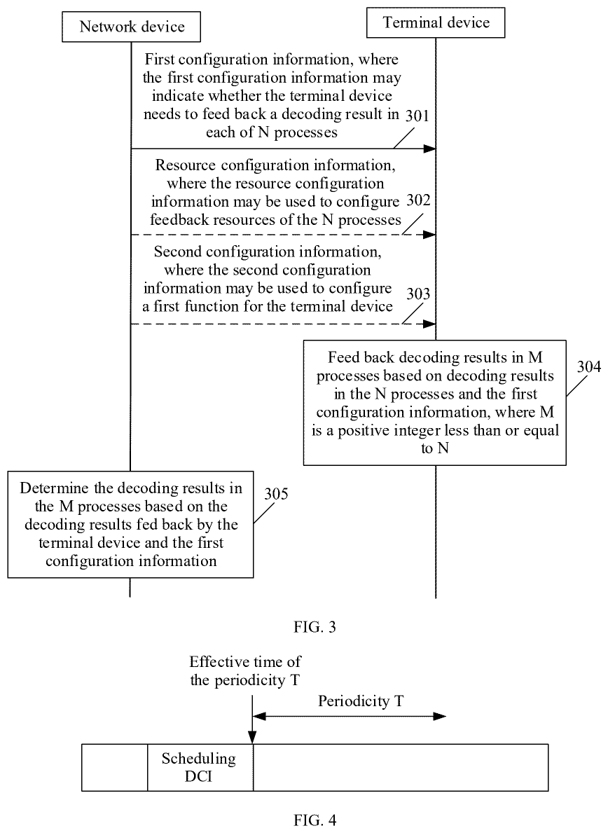

FIG. 4 is a diagram of effective time of the periodicity T according to an embodiment of this application. As shown in FIG. 4, time at which the terminal device receives DCI for scheduling a plurality of TBs may be effective time (or referred to as start time) of the periodicity T. Within duration of the periodicity T, the first function may be in an activated state. After end time of the periodicity T, the terminal device may deactivate the first function, that is, the first function may be in a deactivated state.

In another example, the activation information may be carried in DCI/MAC CE/RRC signaling before the scheduling DCI (the DCI used to schedule the TBs corresponding to the N processes). For example, the activation information includes a value of the periodicity T or an index of the periodicity T. In this case, the terminal device may use time at which the terminal device receives scheduling DCI for the first time after the activation information as the effective time of the periodicity T.

In embodiments of this application, activation and deactivation of the first function are configured based on the periodicity T. Values of the periodicity T may be different with different services. Therefore, this implementation may be more suitable for the services.

### Implementation 3

The first function is activated based on content carried in data. For example, when the terminal device obtains MAC CE by decoding data scheduled based on the scheduling DCI, the terminal device may activate the first function.

The network device may send the MAC CE on at least one of the N processes, and send the MAC CE on the at least one of the N processes to indicate to activate the first function. If the terminal device receives the MAC CE on at least one of the N processes, the terminal device may learn that the MAC CE indicates to activate the first function. For example, the at least one process may be a process in which the first configuration information indicates that a decoding result needs to be fed back Alternatively, the at least one process may be a process in which the first configuration information indicates that a decoding result does not need to be fed back.

For example, if N=2, and a TB corresponding to one of the two processes carries a MAC CE, or a TB corresponding to a process in which it is indicated that a decoding result needs to be fed back in the two processes carries a MAC CE, it indicates that the network device indicates the terminal device to activate the first function.

In embodiments of this application, when N=2, even if decoding results in the two processes are configured not to be fed back, because the terminal device decodes the data scheduled based on the scheduling DCI as the MAC CE, the terminal device may still feed back the decoding result in the MAC CE, to further ensure reliability of a MAC CE transmission.

For other descriptions of the implementation 1 to the implementation 3, further refer to the following example 1 to example 3.

Related descriptions of operation 301 to operation 303 are also applicable to operation 801 to operation 803 in FIG. 8. Details are not described below again.
304: The terminal device feeds back the decoding results in the M processes based on the decoding results in the N processes and the first configuration information, where M is a positive integer less than or equal to N.

Generally, when the network device configures the first configuration information for the terminal device, the terminal device feeds back, based on the first configuration information, decoding results in P processes that need to be fed back by the terminal device in the N processes. The terminal device may feed back the decoding results in the P processes after a latency indicated by a HARQ ACK resource field. However, in embodiments of this application, based on the activated first function, the terminal device may feed back the decoding results in the M processes with reference to the actual decoding result in the process and the first configuration information. The N processes include the M processes. For example, M may be greater than P.

In an example, UE #1 corresponds to first configuration information #1, UE #2 corresponds to the first configuration information #1, a decoding result in a first process in N processes corresponding to the UE #1 is an ACK, and a decoding result in a first process in N processes corresponding to the UE #2 is a NACK. A decoding result fed back by the UE #1 is different from a decoding result fed back by the UE #2. In other words, if the same first configuration information is used, and decoding results in at least one of the N processes are different, decoding results fed back by different terminal devices are different.

In another example, UE #1 corresponds to first configuration information #1, UE #2 corresponds to first configuration information #2, and decoding results in N processes corresponding to the UE #1 are the same as decoding results in N processes corresponding to the UE #2. A decoding result fed back by the UE #1 is different from a decoding result fed back by the UE #2. In other words, if different first configuration information is used, and decoding results in the N processes are completely the same, decoding results fed back by the terminal devices are also different.

The terminal device may feed back the decoding results in the M processes on the first feedback resource based on the decoding result in the process and the first configuration information. The first feedback resource may be a feedback resource corresponding to i processes in the N processes. The i processes may correspond to i feedback resources, and the first feedback resource may include the i feedback resources. Whether the i feedback resources are consecutive in time domain is not limited in embodiments of this application. For example, operation 304 may alternatively be replaced with: The terminal device sends feedback information to the network device based on the decoding result in the process and the first configuration information, where the feedback information includes the decoding results in the M processes. In some embodiments, the terminal device may send the feedback information to the network device on the first feedback resource based on the decoding result in the process and the first configuration information.

For example, an i^{th} feedback resource may be used to feed back decoding results in Mᵢ processes in the M processes. Here, i may be a positive integer, and Mᵢ is a positive integer less than or equal to M. For example, a 1^{st} feedback resource may be used to feed back decoding results in M₁ processes in the M processes, and a 2^{nd} feedback resource may be used to feed back decoding results in M₂ processes in the M processes, and the like. The Mᵢ processes, the M₂ processes, M₃ processes, and the like do not overlap each other. M₁, M₂, M₃, and the like may all be positive integers. For example, at least one of M₁, M₂, M₃, and the like may not be equal to 1. When quantities of processes corresponding to i feedback resources are the same, for example, M₁=M₂=M₃, whether the decoding results in the M₁ processes, the decoding results in the M₂ processes, and the decoding results in the M₃ processes are the same is not limited in embodiments of this application.

In an example, when M=N, i is less than N. The decoding result fed back by the terminal device on the first feedback resource may indicate the decoding results in the N processes. That is, a decoding result fed back by the terminal device on a small quantity of feedback resources may indicate the decoding results in the N processes.

In another example, when M is less than N, i is less than or equal to M. The decoding result fed back by the terminal device on the first feedback resource may indicate the decoding results in the M processes, and the first feedback resource is less than or equal to a feedback resource corresponding to the M processes.

In embodiments of this application, Mᵢ is a quantity of processes indicated by the decoding result fed back by the terminal device on the i^{th} feedback resource. That is, Mᵢ includes both a process in which a decoding result is fed back by the terminal device on the i^{th} feedback resource, and one or more processes in which a decoding result is indicated by the terminal device based on an enhanced mode, the first configuration information, and the i^{th} feedback resource. Generally, one feedback resource may be used to feed back a decoding result in one process. However, in embodiments of this application, Mᵢ may be greater than or equal to 1. For example, for the following example 1, example 2, and example 4, Mᵢ=2, and for the following example 3, Mᵢ=1.

The following uses an example in which the i^{th} feedback resource is used to feed back the decoding results in the Mᵢ processes in the M processes to describe the method provided in embodiments of this application.

For example, the terminal device may feed back the decoding results in the Mᵢ processes based on the following requirements:
1. A feedback priority of a process in which HARQ feedback is enabled and a decoding result is a NACK is higher than a feedback priority of a process in which HARQ feedback is disabled. The process in which HARQ feedback is disabled includes a process in which a decoding result is an ACK or a process in which a decoding result is a NACK.
2. A feedback priority of a process in which HARQ feedback is disabled and a decoding result is a NACK is higher than a feedback priority of a process in which a decoding result is an ACK.
3. A feedback priority of a process in which HARQ feedback is enabled and a decoding result is an ACK is higher than a feedback priority of a process in which HARQ feedback is disabled and a decoding result is an ACK.

For example, with reference to the foregoing requirement 1 to requirement 3, feedback priorities of the following processes are in descending order: a process in which HARQ feedback is enabled and a decoding result is a NACK, a process in which HARQ feedback is disabled and a decoding result is a NACK, a process in which HARQ feedback is enabled and a decoding result is an ACK, and a process in which HARQ feedback is disabled and a decoding result is an ACK. When all the Mᵢ processes are processes in which HARQ feedback is disabled, for a feedback manner of the terminal device, refer to the following example 4.

The process in which HARQ feedback is enabled may also be referred to as a process in which the first configuration information indicates that a decoding result needs to be fed back, a process in which a decoding result is configured, based on the first configuration information, to be fed back, or the like. The process in which HARQ feedback is disabled may also be referred to as a process in which the first configuration information indicates that a decoding result does not need to be fed back, a process in which a decoding result is configured, based on the first configuration information, not to be fed back, the like.

In a possible implementation, Mᵢ=2, the Mᵢ processes include a first process and a second process, and the first configuration information indicates that a terminal device needs to feed back a decoding result in the first process and does not need to feed back a decoding result in the second process.

In an example 1, the decoding result in the first process is that decoding is correct, and the decoding result in the second process is that decoding is incorrect. Based on the foregoing requirement, because the decoding result in the second process is a NACK, and the decoding result in the first process is an ACK, a feedback priority of the second process is higher than a feedback priority of the first process, and the terminal device may send the decoding result (namely, the NACK) of the second process on a feedback resource corresponding to the second process. The i^{th} feedback resource is the feedback resource corresponding to the second process. A feedback resource of the first process and the feedback resource of the second process may be determined based on the HARQ ACK resource field, the subcarrier spacing, and the quantity of HARQ feedback repetitions shown above. Details are not described herein again.

In this example, the first process is a process in which HARQ feedback is enabled, and the second process is a process in which HARQ feedback is disabled. Because the terminal device feeds back the NACK on the feedback resource corresponding to the process in which HARQ feedback is disabled, feeding back the NACK on the feedback resource corresponding to the process in which HARQ feedback is disabled may indicate that the decoding result in the process in which HARQ feedback is enabled is the ACK, and the decoding result in the process in which HARQ feedback is disabled is the NACK. In this example, although the terminal device feeds back the decoding result on one feedback resource, the network device may learn of decoding results in the two processes.

In embodiments of this application, the terminal device feeds back, on one feedback resource, the decoding result in the process in which HARQ feedback is disabled, so that the network device can learn of the decoding results in the first process and the second process based on the feedback resource corresponding to the decoding result and the decoding result. That the terminal device feeds back the NACK on the feedback resource of the second process indicates that the decoding result in the first process is the ACK and the decoding result in the second process is the NACK. This effectively reduces power consumption of the terminal device. With reference to the first configuration information, a location of the feedback resource, and the decoding result (the NACK), the network device may effectively learn of the decoding results in the two processes, to effectively learn of link quality and improve accuracy of channel information prediction and link adaptation adjustment by the network device.

In another example 2, both the decoding result in the first process and the decoding result in the second process are that decoding is correct. Based on the foregoing requirement, because both the decoding result in the first process and the decoding result in the second process are ACKs, the first process is a process in which HARQ feedback is enabled, and the second process is a process in which HARQ feedback is disabled, a feedback priority of the first process is higher than a feedback priority of the second process, and the terminal device may send the decoding result (namely, the ACK) in the first process on a feedback resource corresponding to the first process.

In this example, that the terminal device feeds back the ACK on the feedback resource corresponding to the process in which HARQ feedback is enabled may indicate that the decoding result in the process in which HARQ feedback is enabled is the ACK, and the decoding result in the process in which HARQ feedback is disabled is the ACK. The i^{th} feedback resource is the feedback resource corresponding to the first process. For other descriptions of this example, refer to the foregoing example. Details are not described herein again.

In embodiments of this application, that the terminal device feeds back the ACK on one feedback resource, for example, feeds back the ACK on the feedback resource corresponding to the process in which HARQ feedback is enabled, indicates that both the decoding result in the first process and the decoding result in the second process are ACKs. With reference to the first configuration information, a location of the feedback resource, and the decoding result (the ACK), the network device may effectively learn of the decoding results in the two processes, to effectively learn of link quality and improve accuracy of channel information prediction and link adaptation adjustment by the network device.

In still another example 3, the decoding result in the first process is that decoding is incorrect, and the decoding result in the second process is that decoding is incorrect or decoding is correct. Based on the foregoing requirement, because the decoding result in the first process is a NACK, and the first process is a process in which HARQ feedback is enabled, a feedback priority of the first process is higher than a feedback priority of the second process, and the terminal device may send the decoding result (namely, the NACK) in the first process on a feedback resource corresponding to the first process.

In this example, because the decoding result in the process in which HARQ feedback is enabled is the NACK, the terminal device needs to send the NACK on the feedback resource corresponding to a process in which HARQ feedback is disabled regardless of whether a decoding result in the process in which HARQ feedback is disabled is an ACK or a NACK. The network device may learn, based on the feedback resource corresponding to the decoding result and the decoding result, that the decoding result in the process in which HARQ feedback is enabled is the NACK. In this example, the network device cannot learn of the decoding result in the process in which HARQ feedback is disabled. The i^{th} feedback resource is the feedback resource corresponding to the first process.

In embodiments of this application, that the terminal device feeds back the NACK on the feedback resource corresponding to the process in which the HARQ feedback is enabled indicates that the decoding result in the first process is the NACK.

In another possible implementation, the first configuration information indicates that the terminal device does not need to feed back a decoding result in each of the Mᵢ processes.

In still another example 4, the terminal device may send an ACK or a NACK on the i^{th} feedback resource, where the ACK or the NACK is determined based on the decoding results in the Mᵢ processes. The i^{th} feedback resource may be a feedback resource corresponding to a 1^{st} process in the Mᵢ processes, or a feedback resource whose time domain resource ranks first in the Mᵢ processes.

For example, the ACK or the NACK may be determined based on an operation result of the decoding results in the Mᵢ processes. For example, the i^{th} feedback resource is used to send a decoding result obtained through an AND operation performed on the decoding results in the Mᵢ processes. For example, if the ACK is represented as 1, the NACK is represented as 0, Mᵢ=2, a decoding result in the 1^{st} process is the ACK (namely, 1), and a decoding result in a 2^{nd} process is the NACK, a value obtained through an AND operation performed on 1 and 0 is 0. A decoding result sent on the i^{th} feedback resource is the NACK. For another example, the i^{th} feedback resource is used to send a decoding result obtained through an OR operation performed on the decoding results in the Mᵢ processes. Details are not enumerated herein one by one.

For an example manner in which the network device learns of the decoding result, refer to operation 305. Details are not described herein.

The foregoing example 1 to example 4 are also applicable to another process in the M processes. Related descriptions of Mᵢ−1 processes other than the Mᵢ processes in the M processes are not described in detail herein again. The foregoing uses Mᵢ=2 as an example. For example descriptions when Mᵢ is an even number such as 4, 6, or 8, refer to the foregoing descriptions of Mᵢ=2. Details are not described herein again. For example, when Mᵢ=4, the terminal device may combine every two of four processes according to the method in which Mᵢ=2, and then feed back decoding results based on the foregoing example 1 to example 4. Certainly, the method shown in embodiments of this application is also applicable to a case in which Mᵢ is an odd number.

When there are a plurality of processes in which a decoding result needs to be fed back and a plurality of processes in which a decoding result does not need to be fed back in the Mᵢ processes, embodiments of this application provide the following manner: (1) One result A (for example, in the foregoing example 4) may be obtained through bundling between decoding results in the plurality of processes in which a decoding result needs to be fed back, and one result B may be obtained through bundling between decoding results in the plurality of processes in which a decoding result does not need to be fed back, and then the result A and the result B are fed back in the manner shown in the foregoing example 1 to example 4. (2) One result A is obtained through bundling between decoding results in one or more processes of the plurality of processes in which a decoding result needs to be fed back, a decoding result in one process in which a decoding result does not need to be fed back is a result B, and the result A and the result B are fed back in the manner shown in the foregoing example 1 to example 4. (3) One result A is obtained through bundling between decoding results in one or more processes of the plurality of processes in which a decoding result does not need to be fed back, a decoding result in one process in which a decoding result needs to be fed back is a result B, and the result A and the result B are fed back in the manner shown in the foregoing example 1 to example 4. Details are not described herein again.

In a possible implementation, when configuring the first configuration information for the terminal device, the network device may further configure whether HARQ process feedback can be configured for DCI (for example, scheduling DCI). In an example, when the first configuration information is carried in RRC signaling, and the network device does not configure, through the RRC, that the HARQ process feedback can be configured for the DCI, the terminal device may perform feedback based on the foregoing example. In another example, when the first configuration information is carried in RRC signaling, and the network device configures, through the RRC, that the HARQ process feedback can be configured for the DCI, the terminal device may determine, based on the first configuration information and the DCI, whether the decoding result in each of the N processes needs to be fed back. When the network device configures, through the RRC, that the HARQ process feedback can be configured for the DCI, indication information in the DCI may be used to override the first configuration information. For example, the indication information may occupy one bit. A value of the bit being 0 indicates that the first configuration information is not overridden. The value of the bit being 1 indicates that the first configuration information is overridden. For example, if the first configuration information is 01 and a value of the indication information is 1, it indicates that the first configuration information needs to be overridden, for example, overridden to 10. For another example, the indication information may occupy two bits, the two bits correspond to four indication manners, and each indication manner may represent one overriding manner. After the terminal device determines, based on the first configuration information and the DCI, whether the terminal device needs to feed back the decoding result in each of the N processes, the terminal device may perform feedback based on the foregoing example. Details are not described herein again.
305: The network device determines the decoding results in the M processes based on the decoding result fed back by the terminal device and the first configuration information.

The network device may determine the decoding results in the M processes based on a feedback resource corresponding to the decoding result received by the network device, the decoding result, and the first configuration information. For example, the network device may detect, on two feedback resources corresponding to two processes, whether data exists, and determine decoding results in the two processes based on feedback resources corresponding to the data that is detected by the network device.

For example, in the foregoing example 1, when the network device detects data, the feedback resource is the feedback resource corresponding to the second process, a NACK is fed back on the feedback resource corresponding to the second process, and no data is transmitted on the feedback resource corresponding to the first process, the network device may determine, with reference to the first configuration information, that the decoding result in the first process is an ACK, and the decoding result in the second process is the NACK.

For another example, in the foregoing example 2, the feedback resource on which the network device detects that data is transmitted is the feedback resource corresponding to the first process, an ACK is fed back on the feedback resource corresponding to the first process, and no data is transmitted on the feedback resource corresponding to the second process, the network device may determine, with reference to the first configuration information, that both the decoding result in the first process and the decoding result in the second process are ACKs.

For another example, in the foregoing example 3, the feedback resource on which the network device detects that data is transmitted is the feedback resource corresponding to the first process, a NACK is fed back on the feedback resource corresponding to the first process, and no data is transmitted on the feedback resource corresponding to the second process, the network device may determine, with reference to the first configuration information, that the decoding result in the first process is the NACK.

For another example, in the foregoing example 4, the feedback resource on which the network device detects that data is transmitted is the feedback resource corresponding to the first process, a NACK is fed back on the feedback resource corresponding to the first process, and no data is transmitted on the feedback resource corresponding to the second process, the network device may learn, with reference to the first configuration information, that a decoding result in one of the first process and the second process is the NACK, and a decoding result in the other process is an ACK.

For another example, in the foregoing example 4, the feedback resource on which the network device detects that data is transmitted is the feedback resource corresponding to the first process, an ACK is fed back on the feedback resource corresponding to the first process, and no data is transmitted on the feedback resource corresponding to the second process, the network device may learn, with reference to the first configuration information, that the decoding result in the first process and the decoding result in the second process are both NACKs or both ACKs. For example, if the decoding result detected by the network device on the feedback resource corresponding to the first process is the NACK, the network device may have the following several manners based on different first configuration information.

For example, if the first configuration information indicates that the decoding result in the first process needs to be fed back, and the decoding result in the second process does not need to be fed back, the network device may learn that the decoding result in the first process is a NACK, and the decoding result in the second process is an ACK/NACK.

For another example, if the first configuration information indicates that the decoding result in the first process does not need to be fed back, and the decoding result in the second process needs to be fed back, the network device may learn that the decoding result in the first process is a NACK, and the decoding result in the second process is an ACK.

For another example, if the first configuration information is that neither the decoding result in the first process nor the decoding result in the second process needs to be fed back, the network device may learn that the decoding result in one of the first process and the second process is an ACK, and the decoding result in the other process is a NACK.

For an uplink repeated transmission, refer to FIG. 8. 804: The network device feeds back the decoding results in the M processes based on the decoding results in the N processes and the first configuration information, where M is a positive integer less than or equal to N. 805: The terminal device determines the decoding results in the M processes based on the fed-back decoding results and the first configuration information. For related descriptions of the uplink repeated transmission, refer to operation 304 and operation 305. Details are not described herein again. For related descriptions of operation 801 in FIG. 8, refer to operation 301. For related descriptions of operation 802, refer to operation 302. For related descriptions of operation 803, refer to operation 303. Details are not described herein again.

In embodiments of this application, the terminal device feeds back the decoding results in the M processes based on the first configuration information and the decoding results in the N processes, and the network device may learn of the decoding results in the N processes based on the decoding results in the M processes, or learn of decoding results in processes whose quantity is less than N and greater than M, or learn of the decoding results in the M processes. In this way, a throughput is effectively improved, and accuracy of channel information prediction and link adaptation adjustment by the network device can be effectively improved.

Currently, there is a solution A: Regardless of a decoding result in a process, an ACK is fed back in a process with HARQ feedback disabled or in which HARQ feedback is configured to be disabled (that is, a process in which HARQ feedback is disabled). Currently, there is also a solution B, that is, no decoding result is fed back in a process with HARQ feedback disabled or in which HARQ feedback is configured to be disabled. For the solution A and the solution B, the network device cannot effectively learn of a decoding result in a process in which HARQ feedback is disabled. Consequently, the network device cannot determine link quality and predict channel information, and the network device cannot perform link adaptation adjustment.

Currently, there is further a solution C: Provided that a decoding result in one process is configured to be fed back, decoding results in all processes are fed back. However, the network device needs to feed back a decoding result on a feedback resource corresponding to each process, resulting in a power consumption loss of the terminal device. According to the method provided in embodiments of this application, the terminal device may feed back a decoding result in one or more processes on one feedback resource, to effectively reduce power consumption of the terminal device.

The following further describes the method provided in embodiments of this application by using an example in which N=2 when FIG. 3 is applied to the NB-IoT. For an implementation that is not described in detail in the following method, refer to FIG. 3.

### Example 1

Operation 1: The network device configures related information.
(1) The network device configures a bitmap for HARQ feedback disabling. For related descriptions of the bitmap, refer to operation 301.
(2) The network device configures enabling of enhanced multi-TB scheduling through RRC signaling. The configuration of enabling of enhanced multi-TB scheduling may be activated or deactivated based on DCI or MAC CE. For related descriptions of enabling of enhanced multi-TB scheduling, refer to operation 303. Certainly, as shown in FIG. 3, the network device may not configure enabling of enhanced multi-TB scheduling, for example, the terminal device is configured with enabling of enhanced multi-TB scheduling by default. Related descriptions of enabling of enhanced multi-TB scheduling herein are also applicable to Example 2 and Example 3 below. For related descriptions of activation or deactivation based on the DCI or a MAC CE, refer to the foregoing implementation 1.

When enabling of enhanced multi-TB scheduling is activated, a corresponding feedback resource may be configured based on the scheduling DCI. For example, the feedback resource configured in the scheduling DCI is a feedback resource length of two TBs. In some embodiments, a feedback resource may be configured for both the two processes based on the scheduling DCI. In other words, enabling of enhanced multi-TB scheduling (referred to as an enhanced mode below) is activated, and the two feedback resources configured based on the scheduling DCI take effect. For example, when both processes are configured with HARQ feedback disabled (referred to as both disabled below), or one process is configured with HARQ feedback disabled, and the other process is configured with HARQ feedback enabled (referred to as one enabled and one disabled below), two feedback resources are configured based on the scheduling DCI.
Operation 2: The terminal device receives activation DCI or an activation MAC CE in UE-specific search space, and receives scheduling DCI scrambled by using a C-RNTI. When a value of a unicast planned TB number field in the scheduling DCI is 1, it indicates that a plurality of TBs are dynamically scheduled this time, and the terminal device may feed back a decoding result in a process based on the following three cases. Because the network device configures an enhanced mode for multi-TB scheduling, and the enhanced mode may be activated/deactivated based on DCI (or a MAC CE), in subsequent multi-TB scheduling, the terminal device may select different feedback resources based on whether decoding in the two processes is correct.
Case (a): Both processes are configured as disabled (that is, no decoding result needs to be fed back). Case (b): The two processes are configured as 0 enabled (a decoding result in a process 0 needs to be fed back) and 1 disabled (a decoding result in a process 1 does not need to be fed back). Case (c): The two processes are configured as 0 disabled and 1 enabled. Process numbers of the two processes may be 0 and 1 respectively.

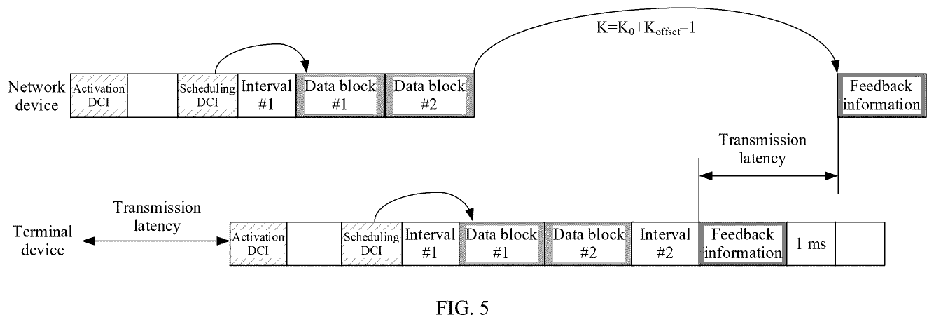

FIG. 5 is a diagram of activating an enhanced mode based on activation DCI according to an embodiment of this application. As shown in FIG. 5, after sending the activation DCI, the network device may send scheduling DCI. A blank between the activation DCI and the scheduling DCI shown in FIG. 5 indicates that the network device may schedule another terminal device. The scheduling DCI may be used to configure related information of a TB scheduled based on the scheduling DCI. As shown in FIG. 5, the scheduling DCI may be used to schedule a data block #1 and a data block #2. Correspondingly, after a specific transmission latency, the terminal device may receive the activation DCI and the scheduling DCI. For example, an interval (an interval #1 shown in FIG. 5) between the scheduling DCI and a 1^{st} data block scheduled based on the scheduling DCI may be 4 ms. For example, an interval (an interval #2 shown in FIG. 5) between time at which the terminal device receives the last data block scheduled based on the scheduling DCI and time at which the terminal device sends feedback information may be 12 ms. Duration of the interval #1 and the interval #2 is not limited in embodiments of this application.

For the case (a), no process is configured as enabled for the network device, and originally, the decoding results in the two processes do not need to be fed back. However, because the enhanced mode is enabled, the terminal device may perform an AND operation on the decoding results in the two processes, and perform feedback after a latency (namely, k₀+k_{offset}−1) indicated by a HARQ ACK resource field. The feedback behavior does not affect subsequent scheduling of the network device. For example, the terminal device may continue to listen to new scheduling 1 ms after sending the feedback information. For other descriptions of the case (a), refer to the descriptions of the example 4 in FIG. 3. 1 ms shown in FIG. 5 is uplink-downlink switching time. The uplink-downlink switching time shown in FIG. 5 is merely an example. A value of the uplink-downlink switching time is not limited in embodiments of this application.

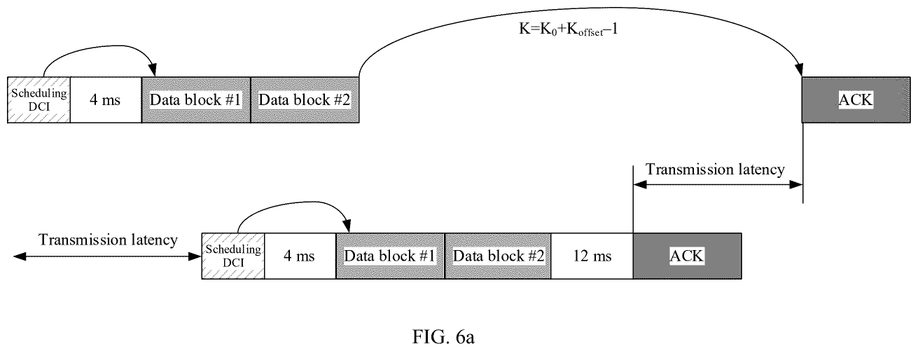

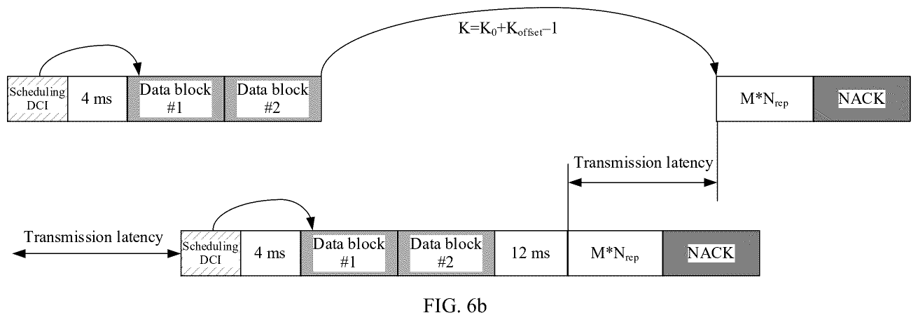

For the case (b), the two processes are configured as 0 enabled and 1 disabled. In an example, when decoding in the process 0 in which HARQ feedback is enabled is correct, and decoding in the process 1 in which HARQ feedback is disabled is incorrect, the terminal device may feed back a NACK at a resource location corresponding to a 2^{nd} TB. That is, the feedback is performed after a latency of K+M*Nᵣₑₚ indicated by a HARQ ACK resource field. As shown in FIG. 6a, when the enhanced mode is not enabled, an original behavior of the terminal device is to feed back, on an uplink resource corresponding to a latency K indicated by the HARQ ACK resource field, namely, K subframes after an end subframe of downlink data, a decoding result ACK of a TB carried on the process 0 in which HARQ feedback is enabled. As shown in FIG. 6a, because the enhanced mode is not enabled, a start location of a feedback resource of the process 0 in which a decoding result needs to be fed back starts from K indicated by the HARQ ACK resource field, and the terminal device feeds back the decoding result ACK in the process 0 after the latency K. As shown in FIG. 6b, after the enhanced mode is activated, the terminal device feeds back, after a latency of K+M*Nᵣₑₚ, a decoding result NACK of a TB carried on the process 1. As shown in FIG. 6b, because the enhanced mode is enabled, both the feedback resource corresponding to the process 0 and a feedback resource corresponding to the process 1 are effective, and the terminal device may perform feedback on the feedback resource corresponding to the process 1 with reference to decoding results in the two processes. In another example, when decoding in the process 0 in which HARQ feedback is enabled is correct and decoding in the process 1 in which HARQ feedback is disabled is correct, the terminal device may feed back an ACK after a latency K indicated by a HARQ ACK resource field. In still another example, when decoding in the process 0 in which HARQ feedback is enabled is incorrect, regardless of whether decoding in the process 1 in which HARQ feedback is disabled is correct, the terminal device feeds back a NACK after a latency K indicated by a HARQ ACK resource field.

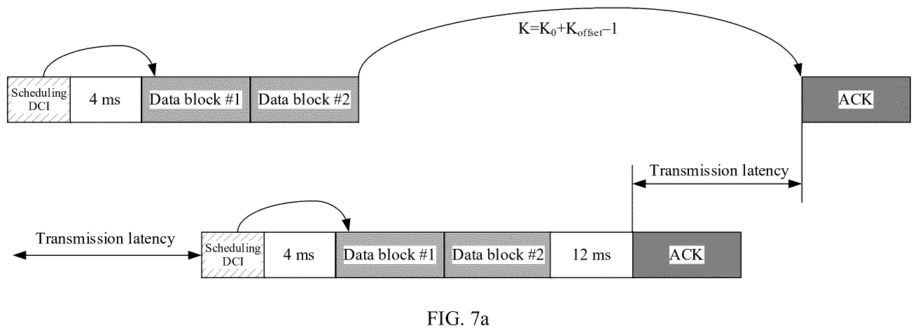

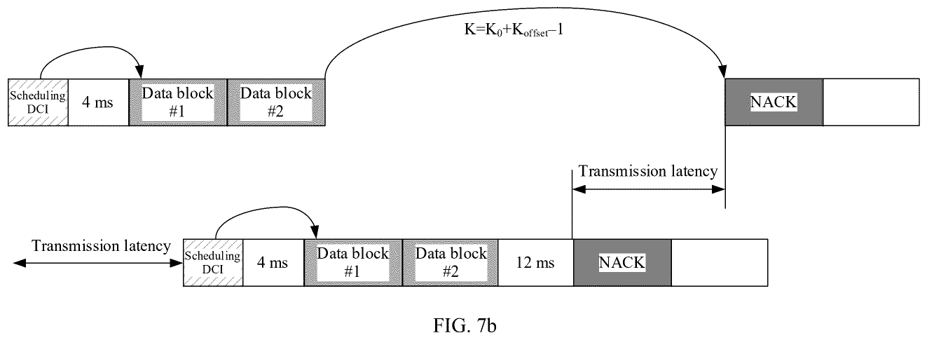

For the case (c), the two processes are configured as 0 disabled and 1 enabled. In an example, when decoding in the process 1 in which HARQ feedback is enabled is correct, and decoding in the process 0 in which HARQ feedback is disabled is incorrect, the terminal device feeds back a NACK on a feedback resource corresponding to a 1^{st} TB, that is, feeds back the NACK after a latency (namely, K) indicated by a HARQ ACK resource field. As shown in FIG. 7a, when the enhanced mode is not enabled, the terminal device feeds back a decoding result ACK in the process 1 after a latency K+M*Nᵣₑₚ. As shown in FIG. 7a, because the enhanced mode is not enabled, a start location of a feedback resource of the process 1 in which a decoding result needs to be fed back starts from K indicated by the HARQ ACK resource field, and the terminal device feeds back the decoding result ACK in the process 1 after K. As shown in FIG. 7b, after the enhanced mode is enabled, the terminal device feeds back the decoding result NACK in the process 0 after the latency K indicated by the HARQ ACK resource field. As shown in FIG. 7b, because the enhanced mode is enabled, both a feedback resource corresponding to the process 0 and the feedback resource corresponding to the process 1 are effective, and the terminal device may perform feedback on the feedback resource corresponding to the process 0 with reference to decoding results in the two processes. In another example, when decoding in the process 1 in which HARQ feedback is enabled is correct and decoding in the process 0 in which HARQ feedback is disabled is correct, the terminal device may feed back an ACK at a resource location corresponding to a 2^{nd} TB, that is, feed back the ACK after a latency K+M*Nᵣₑₚ indicated by a HARQ ACK resource field. In still another example, when decoding in the process 1 in which HARQ feedback is enabled is incorrect, regardless of whether decoding in the process 0 in which HARQ feedback is disabled is correct, the terminal device feeds back a NACK on a feedback resource corresponding to a 2^{nd} TB, that is, feeds back a NACK after a latency K+M*Nᵣₑₚ indicated by a HARQ ACK resource field.

For other descriptions of operation 2, refer to operation 304 shown in FIG. 3. Details are not described herein again.
Operation 3: The network device detects, on feedback resources corresponding to the two TBs, whether data exists, and determines decoding results in the two TBs based on whether there is DTX (where no data is transmitted, and only noise exists) or an ACK/a NACK on the corresponding feedback resources.

For other descriptions of operation 3, refer to operation 305 shown in FIG. 3. Details are not described herein again.

In embodiments of this application, during multi-TB scheduling, if one process is configured with feedback enabled and one process is configured with feedback disabled, a network side cannot learn of complete link quality. In addition, if a terminal feeds back decoding results in all processes, power consumption is increased. In this case, a feedback resource is selected, and a decoding result is fed back, so that link adaptation adjustment can be performed by the network device while power consumption of the terminal is reduced.

### Example 2

Operation 1: The network device configures related information.
(1) The network device configures a bitmap for HARQ feedback disabling. For related descriptions of the bitmap, refer to operation 301.
(2) The network device configures a periodicity T. For example, the periodicity T may take effect by using start time at which the terminal device receives DCI for multi-TB scheduling for the first time. In this way, enabling of enhanced multi-TB scheduling is activated. For example descriptions of operation (2), refer to FIG. 3 or operation (2) in the foregoing Example 1. Details are not described herein again.

The first time indicates that time at which the network device receives scheduling DCI for the first time after the periodicity T is configured is start effective time of the periodicity T.
Operation 2: In effective time of the periodicity T, when the terminal device receives scheduling DCI scrambled by using a C-RNTI, and a value of a unicast planned TB number field in the scheduling DCI is 1, it indicates that a plurality of TBs are dynamically scheduled here. In embodiments of this application, the network device may configure a periodicity for multi-TB scheduling. The periodicity may start to take effect from the first time of scheduling of multi-TB data. The terminal device may select different feedback resources based on whether decoding in two processes is correct.
Operation 3: The network device detects, on feedback resources corresponding to two TBs, whether data exists, and determines decoding results in the two TBs based on whether there is DTX (where no data is transmitted, and only noise exists) or an ACK/a NACK on the corresponding feedback resources.

For related descriptions of operation 2 and operation 3, refer to the foregoing descriptions. Details are not described herein again.

### Example 3

Operation 1: The network device configures related information.
(1) The network device configures a bitmap for HARQ feedback disabling. For related descriptions of the bitmap, refer to operation 301.
(2) The network device configures an enhanced mode.

In a scenario in which two disabled is configured in RRC, if at least one of the two TBs carries a MAC CE, and a corresponding feedback resource is configured in scheduling DCI, a HARQ ACK resource field in the scheduling DCI takes effect.

In a scenario in which one enabled and one disabled are configured in RRC, if a MAC CE is sent in a process in which HARQ feedback is enabled, a feedback resource size in scheduling DCI is a resource for which both processes are enabled.
Operation 2: When DCI received by the terminal in a subframe of UE-specific search space is scrambled by using the C-RNTI, a value of a unicast planned TB number field in the DCI is 1, and the terminal obtains a MAC CE message by decoding data scheduled by using the DCI, the terminal device may feed back a decoding result in a process based on the following three cases.
Operation 3: The network device detects, on feedback resources corresponding to the two TBs, whether data exists, and determines decoding results in the two TBs based on whether there is DTX (where no data is transmitted, and only noise exists) or an ACK/a NACK on the corresponding feedback resources.

For related descriptions of operation 2 and operation 3, refer to the foregoing descriptions. Details are not described herein again.

In embodiments of this application, when the network device configures, for the terminal device, HARQ feedback disabling for multi-TB scheduling, the terminal device may determine, based on HARQ feedback disabling and a decoding result in a process, whether to feed back the decoding result, and determine a feedback resource when the decoding result needs to be fed back. For example, when the network device configures the enhanced mode, the terminal device may activate/deactivate the enhanced mode based on the DCI or the MAC CE (or activate the enhanced mode based on the data carried in the TBs), so that the terminal device may select different feedback resources based on a decoding result in a process in subsequent multi-TB scheduling. For example, the network device may also configure a periodicity for multi-TB scheduling. The periodicity starts to take effect from the first time of scheduling of multi-TB data. In the first time of multi-TB scheduling in a subsequent periodicity, the terminal selects different feedback resources based on whether decoding in the two processes is correct. Originally, a priority of a feedback resource of a process in which HARQ feedback is originally disabled and a decoding result is configured to be fed back is higher, and a length of the feedback resource is a feedback data length of one TB.

In the foregoing embodiments, the network device may configure the first configuration information for multi-TB scheduling for the terminal device, so that the terminal device feeds back the decoding results in the M processes based on the first configuration information and the decoding result in the process. Some other embodiments of this application further provide a satellite communication method. The method is as follows:

The terminal device feeds back the decoding results in the M processes based on the decoding results in the N processes and a mapping relationship. Correspondingly, the network device may determine the decoding results in the M processes based on the mapping relationship and the decoding results received by the network device. Alternatively, the terminal device feeds back the decoding results in the M processes on a second feedback resource based on the decoding results in the N processes and a mapping relationship. Correspondingly, the network device may determine the decoding results in the M processes based on the mapping relationship, the decoding results received by the network device, and the second feedback resource.

The mapping relationship is a mapping relationship between the decoding results in the N processes and feedback results. Alternatively, the mapping relationship may be a mapping relationship between the decoding results in the N processes, feedback results, and feedback resources. Each of the N processes includes two decoding results, and the mapping relationship may be a mapping relationship between 2N decoding results and feedback resources corresponding to the N processes. For descriptions of the N processes and the M processes, refer to the foregoing embodiments. Details are not described herein again. For related descriptions of the second feedback resource, refer to the descriptions of the first feedback resource. Details are not described herein again.

In embodiments of this application, the network device may not configure the first configuration information for the terminal device. Alternatively, the network device may not configure the first configuration information for the terminal device and configure HARQ process feedback by using DCI.

For example, N=2, and the two processes are a process 0 and a process 1. Decoding results in the two processes include: Decoding in the process 0 is correct, and decoding in the process 1 is incorrect (01 shown in Table 1); decoding in the process 0 is incorrect, and decoding in the process 1 is correct (10 shown in Table 1); both decoding in the process 0 and decoding in the process 1 are correct (00 shown in Table 1); or both decoding in the process 0 and decoding in the process 1 are incorrect (11 shown in Table 1).

Feedback results include: performing feedback on a feedback resource corresponding to the process 0; and performing feedback on a feedback resource corresponding to the process 1.

The mapping relationship may be shown in Table 1.

TABLE 1

| | Feedback resource | Feedback resource |
|---|---|---|
| | corresponding to the | corresponding to the |
| | process 0 | process 1 |
| 01 | | NACK |
| 10 | NACK | |
| 00 | | ACK |
| 11 | ACK | |

For another example, N=3, and the three processes are a process 0, a process 1, and a process 2. Decoding results in the three processes include: Decoding in the process 0 to the process 2 is correct (000 shown in Table 2); both decoding in the process 0 and decoding in the process 1 are correct, and decoding in the process 2 is incorrect (001 shown in Table 2); both decoding in the process 0 and decoding in the process 2 are correct, and decoding in the process 1 is incorrect (010 shown in Table 2); both decoding in the process 1 and decoding in the process 2 is incorrect, and decoding in the process 0 is correct (011 shown in Table 2); and the like. Details are not described herein again.

Feedback results include: performing feedback on a feedback resource corresponding to the process 0; performing feedback on a feedback resource corresponding to the process 1; performing feedback on a feedback resource corresponding to the process 2; performing feedback on feedback resources corresponding to two of the three processes; or performing feedback on feedback resources corresponding to the three processes.

Table 2 shows an example of the mapping relationship. The example shown in Table 2 is merely an example, and should not be construed as a limitation on embodiments of this application.

TABLE 2

| | Feedback resource | Feedback resource | Feedback resource |
|---|---|---|---|
| | corresponding to the | corresponding to the | corresponding to the |
| | process 0 | process 1 | process 2 |
| 000 | | | |
| 001 | NACK | | |
| 010 | ACK | | |
| 011 | | NACK | |
| 100 | | ACK | |
| 101 | | | NACK |
| 110 | | | ACK |
| 111 | ACK | ACK | |

Communication apparatuses provided in embodiments of this application are described below.

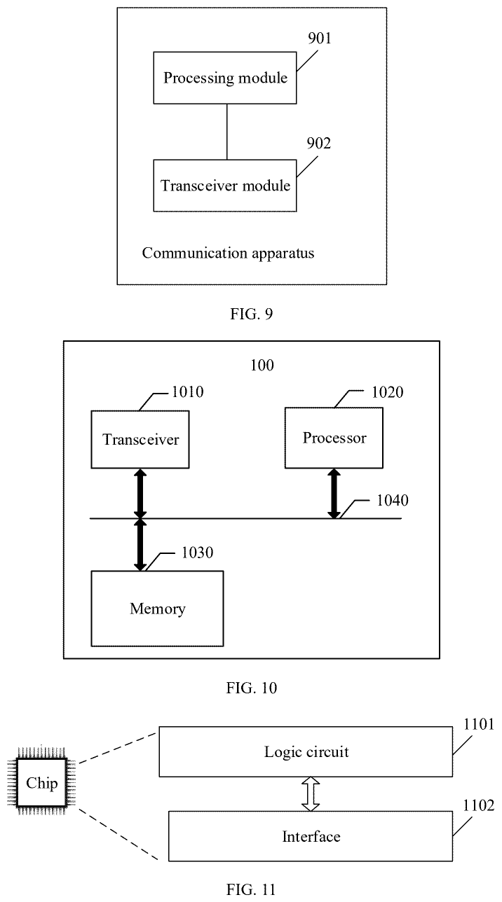

In this application, the communication apparatus is divided into functional modules based on the foregoing method embodiments. For example, each functional module may be divided to each corresponding function, or two or more functions may be integrated into one processing module. The integrated module may be implemented in a form of hardware, or may be implemented in a form of a software functional module. It should be noted that, in this application, module division is an example, and is merely logical function division. In actual implementation, another division manner may be used. The following describes in detail communication apparatuses in embodiments of this application with reference to FIG. 9 to FIG. 11.

FIG. 9 is a diagram of a structure of a communication apparatus according to an embodiment of this application. As shown in FIG. 9, the communication apparatus includes a processing module 901 and a transceiver module 902. The transceiver module 902 may implement a corresponding communication function, and the processing module 901 is configured to process data. For example, the transceiver module 902 may also be referred to as an interface, a communication interface, or a communication module.

In some embodiments of this application, the communication apparatus may be configured to perform an action performed by the first communication apparatus in the foregoing method embodiments. For example, the first communication apparatus may be a terminal device, or a chip or a functional module that may be configured in a terminal device. The transceiver module 902 is configured to perform a receiving and sending-related operation of the terminal device in the foregoing method embodiments, and the processing module 901 is configured to perform a processing-related operation of the terminal device in the foregoing method embodiments.

For example, the transceiver module 902 is configured to receive or enter first configuration information; and the processing module 901 is configured to feed back decoding results in M processes based on decoding results in N processes and the first configuration information.

For example, the transceiver module 902 is configured to receive or enter second configuration information.

For example, the transceiver module 902 is configured to receive or enter activation information.

For example, the processing module 901 is configured to feed back the decoding results in the M processes on a first feedback resource based on the decoding results in the N processes and the first configuration information.

For example, the processing module 901 is configured to send an acknowledgment ACK or a negative acknowledgment NACK on an i^{th} feedback resource.

For example, the processing module 901 is configured to: when a decoding result in a first process is that decoding is correct, and a decoding result in a second process is that decoding is incorrect, feed back a negative acknowledgment NACK on a feedback resource corresponding to the second process; or when both a decoding result in a first process and a decoding result in a second process are that decoding is correct, feed back an acknowledgment ACK on a feedback resource corresponding to the first process.

For example, the processing module 901 may be further configured to feed back the decoding results in the M processes based on the decoding results in the N processes and a mapping relationship. Details are not described herein again.

Refer to FIG. 9 again. In some other embodiments of this application, the communication apparatus may be configured to perform an action performed by the second communication apparatus in the foregoing method embodiments. For example, the second communication apparatus may be a network device or a chip or a functional module that may be configured in a network device. The transceiver module 902 is configured to perform a receiving and sending-related operation of the network device in the foregoing method embodiments, and the processing module 901 is configured to perform a processing-related operation of the network device in the foregoing method embodiments.

For example, the transceiver module 902 is configured to send or output first configuration information; and the processing module 901 is configured to determine decoding results in M processes based on a decoding result fed back by a terminal device and the first configuration information.

For example, the transceiver module 902 is further configured to send or output second configuration information.

For example, the transceiver module 902 is further configured to send or output activation information.

For example, the processing module 901 is configured to determine the decoding results in the M processes based on the decoding result fed back by the terminal device, the first configuration information, and a first feedback resource.

For example, the processing module 901 is configured to receive an acknowledgment ACK or a negative acknowledgment NACK on an i^{th} feedback resource; and determine the decoding results in the M processes based on the i^{th} feedback resource and the ACK or the NACK.

For example, the processing module 901 is configured to: determine, based on the first configuration information and a NACK received on a feedback resource corresponding to a second process, that a decoding result in a first process is that decoding is correct, and a decoding result in the second process is that decoding is incorrect; or determine, based on the first configuration information and an ACK received on a feedback resource corresponding to a first process, that both a decoding result in the first process and a decoding result in a second process are that decoding is correct.

For example, the processing module 901 may be further configured to determine the decoding results in the M processes based on the fed-back decoding result and a mapping relationship. Details are not described herein again.

Refer to FIG. 9 again. In some embodiments of this application, the communication apparatus may be configured to perform an action performed by the first communication apparatus in the foregoing method embodiments. For example, the first communication apparatus may be a network device or a chip or a functional module that may be configured in a network device. The transceiver module 902 is configured to perform a receiving and sending-related operation of the network device in the foregoing method embodiments, and the processing module 901 is configured to perform a processing-related operation of the network device in the foregoing method embodiments.

For example, the transceiver module 902 is configured to send or output first configuration information; and the processing module 901 is configured to feed back decoding results in M processes based on decoding results in N processes and the first configuration information.

For example, the transceiver module 902 is further configured to send or output second configuration information.

For example, the transceiver module 902 is further configured to send or output activation information.

For example, the processing module 901 is configured to feed back the decoding results in the M processes on a first feedback resource based on the decoding results in the N processes and the first configuration information.

For example, the processing module 901 is configured to send an acknowledgment ACK or a negative acknowledgment NACK on an i^{th} feedback resource.

For example, the processing module 901 is configured to: when a decoding result in a first process is that decoding is correct, and a decoding result in a second process is that decoding is incorrect, feed back a negative acknowledgment NACK on a feedback resource corresponding to the second process; or when both a decoding result in a first process and a decoding result in a second process are that decoding is correct, feed back an acknowledgment ACK on a feedback resource corresponding to the first process.

For example, the processing module 901 may be further configured to feed back the decoding results in the M processes based on the decoding results in the N processes and a mapping relationship. Details are not described herein again.

Refer to FIG. 9 again. In some other embodiments of this application, the communication apparatus may be configured to perform an action performed by the second communication apparatus in the foregoing method embodiments. For example, the second communication apparatus may be a terminal device, or a chip or a functional module that may be configured in a terminal device. The transceiver module 902 is configured to perform a receiving and sending-related operation of the terminal device in the foregoing method embodiments, and the processing module 901 is configured to perform a processing-related operation of the terminal device in the foregoing method embodiments.

For example, the transceiver module 902 is configured to receive or enter first configuration information; and the processing module 901 is configured to determine decoding results in M processes based on a decoding result fed back by a network device and the first configuration information.

For example, the transceiver module 902 is configured to receive or enter second configuration information.

For example, the transceiver module 902 is configured to receive or enter activation information.

For example, the processing module 901 is configured to determine the decoding results in the M processes based on the decoding result fed back by the network device, the first configuration information, and a first feedback resource.

For example, the processing module 901 is configured to receive an acknowledgment ACK or a negative acknowledgment NACK on an i^{th} feedback resource; and determine the decoding results in the M processes based on the i^{th} feedback resource and the ACK or the NACK.

For example, the processing module 901 is configured to: determine, based on the first configuration information and a NACK received on a feedback resource corresponding to a second process, that a decoding result in a first process is that decoding is correct, and a decoding result in the second process is that decoding is incorrect; or determine, based on the first configuration information and an ACK received on a feedback resource corresponding to a first process, that both a decoding result in the first process and a decoding result in a second process are that decoding is correct.

For example, the processing module 901 may be further configured to determine the decoding results in the M processes based on the fed-back decoding result and a mapping relationship. Details are not described herein again.

In some embodiments, in the foregoing embodiments, the communication apparatus may further include a storage module. The storage module may be configured to store instructions and/or data. The processing module 901 may read the instructions and/or data in the storage module, so that the communication apparatus implements the foregoing method embodiments.

In the foregoing embodiments, for example descriptions of terms or operations such as the first configuration information, the second configuration information, the activation information, the feedback resource, and the mapping relationship, refer to the descriptions in the foregoing method embodiments. Details are not described herein again.

Descriptions of the transceiver module and the processing module shown in the foregoing embodiments are merely examples. For example functions or operations performed by the transceiver module and the processing module, refer to the foregoing method embodiments. Details are not described herein again.

The foregoing describes the communication apparatus in embodiments of this application. The following describes a possible product form of the communication apparatus. Any form of product that has a function of the communication apparatus described in FIG. 9 falls within the protection scope of embodiments of this application. The following descriptions are merely examples, and a product form of the communication apparatus in embodiments of this application is not limited thereto.

In a possible implementation, in the communication apparatus shown in FIG. 9, the processing module 901 may be one or more processors, and the transceiver module 902 may be a transceiver; or the transceiver module 902 may be a sending module and a receiving module, the sending module may be a transmitter, and the receiving module may be a receiver, and the sending module and the receiving module are integrated into one device, for example, a transceiver. In embodiments of this application, the processor and the transceiver may be coupled, or the like. A connection manner between the processor and the transceiver is not limited in embodiments of this application. In a process of performing the foregoing method, a process of sending information in the foregoing method may be a process of outputting the information by the processor. When outputting the information, the processor outputs the information to the transceiver, so that the transceiver transmits the information. After the information is outputted by the processor, other processing may further need to be performed on the information before the information arrives at the transceiver. Similarly, a process of receiving information in the foregoing method may be a process of receiving the entered information by the processor. When the processor receives the entered information, the transceiver receives the information, and enters the information into the processor. Further, after the transceiver receives the information, other processing may need to be performed on the information before processed information is entered into the processor.

As shown in FIG. 10, a communication apparatus 100 includes one or more processors 1020 and a transceiver 1010.

In some embodiments of this application, when the communication apparatus is configured to perform the operations, methods, or functions performed by the first communication apparatus (for example, the terminal device), the transceiver 1010 is configured to receive first configuration information, and the processor 1020 is configured to feed back decoding results in M processes based on decoding results in N processes and the first configuration information.

For example, the transceiver 1010 is configured to receive second configuration information.

For example, the transceiver 1010 is configured to receive activation information.

For example, the processor 1020 is configured to feed back the decoding results in the M processes on a first feedback resource based on the decoding results in the N processes and the first configuration information.

For example, the processor 1020 is configured to send an acknowledgment ACK or a negative acknowledgment NACK on an i^{th} feedback resource.

For example, the processor 1020 is configured to: when a decoding result in a first process is that decoding is correct, and a decoding result in a second process is that decoding is incorrect, feed back a negative acknowledgment NACK on a feedback resource corresponding to the second process; or when both a decoding result in a first process and a decoding result in a second process are that decoding is correct, feed back an acknowledgment ACK on a feedback resource corresponding to the first process.

In some other embodiments of this application, when the communication apparatus is configured to perform the operations, methods, or functions performed by the second communication apparatus (for example, the network device), the transceiver 1010 is configured to send first configuration information, and the processor 1020 is configured to determine decoding results in M processes based on a decoding result fed back by a terminal device and the first configuration information.

For example, the transceiver 1010 is further configured to send second configuration information.

For example, the transceiver 1010 is further configured to send activation information.

For example, the processor 1020 is configured to determine the decoding results in the M processes based on the decoding result fed back by the terminal device, the first configuration information, and a first feedback resource.

For example, the processor 1020 is configured to receive an acknowledgment ACK or a negative acknowledgment NACK on an i^{th} feedback resource; and determine the decoding results in the M processes based on the i^{th} feedback resource and the ACK or the NACK.

For example, the processor 1020 is configured to: determine, based on the first configuration information and a NACK received on a feedback resource corresponding to a second process, that a decoding result in a first process is that decoding is correct, and a decoding result in the second process is that decoding is incorrect; or determine, based on the first configuration information and an ACK received on a feedback resource corresponding to a first process, that both a decoding result in the first process and a decoding result in a second process are that decoding is correct.

In some embodiments of this application, when the communication apparatus is configured to perform the operations, methods, or functions performed by the first communication apparatus (for example, the network device), the transceiver 1010 is configured to send first configuration information, and the processor 1020 is configured to feed back decoding results in M processes based on decoding results in N processes and the first configuration information.

For example, the transceiver 1010 is further configured to send second configuration information.

For example, the transceiver 1010 is further configured to send activation information.

For example, the processor 1020 is configured to feed back the decoding results in the M processes on a first feedback resource based on the decoding results in the N processes and the first configuration information.

For example, the processor 1020 is configured to send an acknowledgment ACK or a negative acknowledgment NACK on an i^{th} feedback resource.

For example, the processor 1020 is configured to: when a decoding result in a first process is that decoding is correct, and a decoding result in a second process is that decoding is incorrect, feed back a negative acknowledgment NACK on a feedback resource corresponding to the second process; or when both a decoding result in a first process and a decoding result in a second process are that decoding is correct, feed back an acknowledgment ACK on a feedback resource corresponding to the first process.

In some other embodiments of this application, when the communication apparatus is configured to perform the operations, methods, or functions performed by the second communication apparatus (for example, the terminal device), the transceiver 1010 is configured to receive first configuration information, and the processor 1020 is configured to determine decoding results in M processes based on a decoding result fed back by a network device and the first configuration information.

For example, the transceiver 1010 is configured to receive second configuration information.

For example, the transceiver 1010 is configured to receive activation information.

For example, the processor 1020 is configured to determine the decoding results in the M processes based on the decoding result fed back by the network device, the first configuration information, and a first feedback resource.

For example, the processor 1020 is configured to receive an acknowledgment ACK or a negative acknowledgment NACK on an i^{th} feedback resource; and determine the decoding results in the M processes based on the i^{th} feedback resource and the ACK or the NACK.

For example, the processor 1020 is configured to: determine, based on the first configuration information and a NACK received on a feedback resource corresponding to a second process, that a decoding result in a first process is that decoding is correct, and a decoding result in the second process is that decoding is incorrect; or determine, based on the first configuration information and an ACK received on a feedback resource corresponding to a first process, that both a decoding result in the first process and a decoding result in a second process are that decoding is correct.

In the foregoing embodiments, for example descriptions of terms or operations such as the first configuration information, the second configuration information, the activation information, the feedback resource, and the mapping relationship, refer to the descriptions in the foregoing method embodiments. Details are not described herein again.

In implementations of the communication apparatus shown in FIG. 10, the transceiver may include a receiver and a transmitter. The receiver is configured to perform a receiving function (or operation). The transmitter is configured to perform a transmitting function (or operation). In addition, the transceiver is configured to communicate with another device/apparatus through a transmission medium.

In some embodiments, the communication apparatus 100 may further include one or more memories 1030, configured to store program instructions and/or data. The memory 1030 is coupled to the processor 1020. The coupling in embodiments of this application may be an indirect coupling or a communication connection between apparatuses, units, or modules in an electrical form, a mechanical form, or another form, and is used for information exchange between the apparatuses, the units, or the modules. The processor 1020 may operate in cooperation with the memory 1030. The processor 1020 may execute the program instructions stored in the memory 1030. In some embodiments, at least one of the one or more memories may be included in the processor.

In embodiments of this application, a connection medium between the transceiver 1010, the processor 1020, and the memory 1030 is not limited. In embodiments of this application, the memory 1030, the processor 1020, and the transceiver 1010 are connected through a bus 1040 in FIG. 10. The bus is represented through a thick line in FIG. 10. A connection manner of other components is merely an example for description and is not limited thereto. The bus may be classified into an address bus, a data bus, a control bus, or the like. For ease of representation, only one thick line is used to represent the bus in FIG. 10, but this does not mean that there is only one bus or only one type of bus.

In embodiments of this application, the processor may be a general-purpose processor, a digital signal processor, an application-specific integrated circuit, a field programmable gate array or another programmable logic device, a discrete gate or transistor logic device, a discrete hardware component, or the like. The processor can implement or execute the methods, the operations, and the logical block diagrams disclosed in embodiments of this application. The general-purpose processor may be a microprocessor or any conventional processor or the like. The operations of the method disclosed with reference to embodiments of this application may be directly performed by a hardware processor, or may be performed by using a combination of hardware and software modules in the processor.

In embodiments of this application, the memory may include but is not limited to a nonvolatile memory like a hard disk drive (HDD) or a solid-state drive (SSD), a random access memory (RAM), an erasable programmable read-only memory (EPROM), a read-only memory (ROM), or a portable read-only memory (e.g., Compact Disc Read-Only Memory, CD-ROM). The memory is any storage medium that can be used to carry or store program code in a form of an instruction or a data structure and that can be read and/or written by a computer (for example, the communication apparatus shown in this application). However, this application is not limited thereto. The memory in embodiments of this application may alternatively be a circuit or any other apparatus that can implement a storage function, and is configured to store the program instructions and/or the data.

The processor 1020 is mainly configured to process a communication protocol and communication data, control the entire communication apparatus, execute a software program, and process data of the software program. The memory 1030 is mainly configured to store the software program and data. The transceiver 1010 may include a control circuit and an antenna. The control circuit is mainly configured to perform conversion between a baseband signal and a radio frequency signal and process the radio frequency signal. The antenna is mainly configured to receive and send a radio frequency signal in a form of an electromagnetic wave. An input/output apparatus, for example, a touchscreen, a display, or a keyboard, is mainly configured to: receive data entered by a user and output data to the user.

After the communication apparatus is powered on, the processor 1020 may read a software program in the memory 1030, interpret and execute instructions of the software program, and process data of the software program. When data needs to be sent wirelessly, the processor 1020 performs baseband processing on the to-be-sent data, and then outputs a baseband signal to a radio frequency circuit. The radio frequency circuit performs radio frequency processing on the baseband signal, and then sends a radio frequency signal in a form of electromagnetic wave through the antenna. When data is sent to the communication apparatus, the radio frequency circuit receives the radio frequency signal through the antenna, converts the radio frequency signal into a baseband signal, and outputs the baseband signal to the processor 1020. The processor 1020 converts the baseband signal into data, and processes the data.

In another implementation, the radio frequency circuit and the antenna may be disposed independent of the processor that performs baseband processing. For example, in a distributed scenario, the radio frequency circuit and the antenna may be disposed remotely and independent of the communication apparatus.

The communication apparatus shown in embodiments of this application may further have more components than those in FIG. 10, or the like. This is not limited in embodiments of this application. The methods performed by the processor and the transceiver are merely examples. For example operations performed by the processor and the transceiver, refer to the methods described above.

In another possible implementation, in the communication apparatus shown in FIG. 9, the processing module 901 may be one or more logic circuits, and the transceiver module 902 may be an input/output interface, or may be referred to as a communication interface, an interface circuit, an interface, or the like. Alternatively, the transceiver module 902 may be a sending module and a receiving module. The sending module may be an output interface, and the receiving module may be an input interface. The sending module and the receiving module are integrated into one module, for example, an input/output interface. As shown in FIG. 11, a communication apparatus shown in FIG. 11 includes a logic circuit 1101 and an interface 1102. In some embodiments, the processing module 901 may be implemented through the logic circuit 1101, and the transceiver module 902 may be implemented through the interface 1102. The logic circuit 1101 may be a chip, a processing circuit, an integrated circuit, a system on chip (SoC) chip, or the like. The interface 1102 may be a communication interface, an input/output interface, a pin, or the like. For example, FIG. 11 shows an example in which the communication apparatus is a chip. The chip includes the logic circuit 1101 and the interface 1102.

In embodiments of this application, the logic circuit and the interface may be coupled to each other. A manner of a connection between the logic circuit and the interface is not limited in embodiments of this application.

In some embodiments of this application, when the communication apparatus is configured to perform the operations, methods, or functions performed by the first communication apparatus (for example, the terminal device), the interface 1102 is configured to enter first configuration information, and the logic circuit 1101 is configured to feed back decoding results in M processes based on decoding results in N processes and the first configuration information.

In some other embodiments of this application, when the communication apparatus is configured to perform the operations, methods, or functions performed by the second communication apparatus (for example, the network device), the interface 1102 is configured to output first configuration information, and the logic circuit 1101 is configured to determine decoding results in M processes based on a decoding result fed back by a terminal device and the first configuration information.

In some embodiments of this application, when the communication apparatus is configured to perform the operations, methods, or functions performed by the first communication apparatus (for example, the network device), for example, the interface 1102 is configured to output first configuration information, and the logic circuit 1101 is configured to feed back decoding results in M processes based on decoding results in N processes and the first configuration information.

In some other embodiments of this application, when the communication apparatus is configured to perform the operations, methods, or functions performed by the second communication apparatus (for example, the terminal device), for example, the interface 1102 is configured to enter first configuration information, and the logic circuit 1101 is configured to determine decoding results in M processes based on a decoding result fed back by the network device and the first configuration information.

The foregoing descriptions of the communication apparatus are merely examples. For example descriptions of the communication apparatus shown in FIG. 11, refer to the foregoing method embodiments or FIG. 9 or FIG. 10. Details are not described herein again.

The communication apparatus shown in embodiments of this application may implement the methods provided in embodiments of this application in a form of hardware, or may implement the methods provided in embodiments of this application in a form of software. This is not limited in embodiments of this application.

In the foregoing embodiments, for example descriptions of terms or operations such as the first configuration information, the second configuration information, the activation information, the feedback resource, and the mapping relationship, refer to the descriptions in the foregoing method embodiments. Details are not described herein again. For example implementations of embodiments shown in FIG. 11, further refer to the foregoing embodiments. Details are not described herein again.

An embodiment of this application further provides a communication system. The communication system includes a first communication apparatus and a second communication apparatus. The first communication apparatus and the second communication apparatus may be configured to perform the method in any one of the foregoing embodiments.

In addition, this application further provides a computer program, and the computer program is used to implement operations and/or processing performed by the communication apparatus in the method provided in this application.

This application further provides a computer-readable storage medium. The computer-readable storage medium stores computer code. When the computer code is run on a computer, the computer is enabled to perform operations and/or processing performed by each communication apparatus in the method provided in this application.

This application further provides a computer program product. The computer program product includes computer code or a computer program. When the computer code or the computer program is run on a computer, an operation and/or processing performed by the function entities in the methods provided in this application are/is performed.

In the several embodiments provided in this application, it should be understood that the disclosed system, apparatus, and method may be implemented in other manners. For example, the described apparatus embodiments are merely examples. For example, division into the modules is merely logical function division and may be other division in actual implementation. For example, a plurality of modules or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The modules described as separate parts may or may not be physically separate, and parts displayed as modules may or may not be physical modules, may be located in one position, or may be distributed on a plurality of network modules. Some or all of the modules may be selected based on an actual requirement to achieve the technical effect of the solutions provided in embodiments of this application.

In addition, functional modules in embodiments of this application may be integrated into one processing module, or each of the modules may exist alone physically, or two or more modules may be integrated into one module. The integrated module may be implemented in a form of hardware, or may be implemented in a form of a software functional module.

When the integrated module is implemented in the form of a software functional module and sold or used as an independent product, the integrated unit may be stored in a computer-readable storage medium. Based on such an understanding, the technical solutions of this application essentially, or the part contributing to the current technology, or all or some of the technical solutions may be implemented in a form of a software product. The computer software product is stored in a readable storage medium, and includes several instructions for enabling a computer device (which may be a personal computer, a server, or a network device) to perform all or some of the operations of the methods described in embodiments of this application. The readable storage medium includes any medium that can store program code, such as a USB flash drive, a removable hard disk, a read-only memory (ROM), a random access memory (RAM), a magnetic disk, or an optical disc.

The foregoing descriptions are merely example implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A satellite communication method, comprising:
receiving first configuration information, wherein the first configuration information indicates whether a terminal device needs to feed back a decoding result in each of N processes, and N is an integer greater than or equal to 2; and
feeding back decoding results in M processes based on decoding results in the N processes and the first configuration information, wherein the N processes comprise the M processes, and M is a positive integer less than or equal to N.

2. The method according to claim 1, wherein receiving the first configuration information comprises:
receiving the first configuration information and second configuration information, wherein the second configuration information is used to configure a first function for the terminal device, and the first function indicates that the terminal device is allowed to feed back the decoding results in the M processes based on the decoding results in the N processes and the first configuration information.

3. The method according to claim 2, wherein when a medium access control (MAC) control element (CE) is received on at least one of the N processes, the first function is indicated to be activated.

4. The method according to claim 1, wherein feeding back the decoding results in the M processes based on the decoding results in the N processes and the first configuration information comprises:
feeding back the decoding results in the M processes on a first feedback resource based on the decoding results in the N processes and the first configuration information, wherein the first feedback resource is a feedback resource corresponding to i processes in the N processes, and i is less than N when M equals N, or i is less than or equal to M when M is less than N.

5. The method according to claim 4, wherein the first feedback resource comprises i feedback resources, an i^{th} feedback resource is used to feed back decoding results in Mᵢ processes in the M processes, and Mᵢ is an integer greater than 1 and less than M.

6. The method according to claim 5, wherein the first configuration information indicates that the terminal device does not need to feed back a decoding result in each of the Mᵢ processes, and feeding back the decoding results in the M processes based on the decoding results in the N processes and the first configuration information comprises:
sending an acknowledgment (ACK) or a negative acknowledgment (NACK) on the i^{th} feedback resource, wherein the ACK or the NACK is determined based on the decoding results in the Mᵢ processes.

7. The method according to claim 1, wherein the first configuration information comprises a bitmap, each bit in the bitmap corresponds to one process in the N processes, and a value of the bit indicates whether the terminal device is to feed back a decoding result in a corresponding process in the N processes.

8. A communication apparatus, comprising:
at least one processor; and
one or more memories coupled to the at least one processor and storing program instructions for execution by the at least one processor to:
receive first configuration information, wherein the first configuration information indicates whether a terminal device is to feed back a decoding result in each of N processes, and N is an integer greater than or equal to 2; and
feed back decoding results in M processes based on decoding results in the N processes and the first configuration information, wherein the N processes comprise the M processes, and M is a positive integer less than or equal to N.

9. The apparatus according to claim 8, wherein receive the first configuration information comprises:
receive the first configuration information and second configuration information, wherein the second configuration information is used to configure a first function for the terminal device, and the first function indicates that the terminal device is allowed to feed back the decoding results in the M processes based on the decoding results in the N processes and the first configuration information.

10. The apparatus according to claim 9, wherein when a medium access control (MAC) control element (CE) is received on at least one of the N processes, the first function is indicated to be activated.

11. The apparatus according to claim 8, wherein feed back the decoding results in the M processes based on the decoding results in the N processes and the first configuration information comprises:
feed back the decoding results in the M processes on a first feedback resource based on the decoding results in the N processes and the first configuration information, wherein the first feedback resource is a feedback resource corresponding to i processes in the N processes, and i is less than N when M equals N, or i is less than or equal to M when M is less than N.

12. The apparatus according to claim 11, wherein the first feedback resource comprises i feedback resources, an i^{th} feedback resource is used to feed back decoding results in Mᵢ processes in the M processes, and Mᵢ is an integer greater than 1 and less than M.

13. The apparatus according to claim 12, wherein the first configuration information indicates that the terminal device does not need to feed back a decoding result in each of the Mᵢ processes, and feed back the decoding results in the M processes based on the decoding results in the N processes and the first configuration information comprises:
send an acknowledgment (ACK) or a negative acknowledgment (NACK) on the i^{th} feedback resource, wherein the ACK or the NACK is determined based on the decoding results in the Mᵢ processes.

14. A communication apparatus, comprising:
at least one processor; and
one or more memories coupled to the at least one processor and storing program instructions for execution by the at least one processor to:
send first configuration information, wherein the first configuration information indicates whether a terminal device needs to feed back a decoding result in each of N processes, and N is an integer greater than or equal to 2; and
determine decoding results in M processes based on the decoding result fed back by the terminal device and the first configuration information, wherein the N processes comprise the M processes, and Mis an integer less than or equal to N.

15. The apparatus according to claim 14, wherein send the first configuration information comprises:
send the first configuration information and second configuration information, wherein the second configuration information is used to configure a first function for the terminal device, and the first function indicates that the terminal device is allowed to feed back the decoding results in the M processes based on decoding results in the N processes and the first configuration information.

16. The apparatus according to claim 15, wherein the one or more memories further storing program instructions for execution by the at least one processor to:
send activation information, wherein the activation information is used to activate the first function.

17. The apparatus according to claim 16, wherein the activation information comprises downlink control information (DCI) or a medium access control (MAC) control element (CE); or
the activation information indicates a periodicity T, and the periodicity T is an effective periodicity of the first function.

18. The apparatus according to claim 14, wherein determine the decoding results in the M processes based on the decoding result fed back by the terminal device and the first configuration information comprises:
determine the decoding results in the M processes based on the decoding result fed back by the terminal device, the first configuration information, and a first feedback resource, wherein the first feedback resource is a feedback resource corresponding to i processes in the N processes, and i is less than N when M equals N, or i is less than or equal to M when M is less than N.

19. The apparatus according to claim 18, wherein the first feedback resource comprises i feedback resources, an i^{th} feedback resource is used to feed back decoding results in Mᵢ processes in the M processes, and Mᵢ is an integer greater than 1 and less than M;
wherein the first configuration information indicates that the terminal device does not need to feed back a decoding result in each of the Mᵢ processes, and determine the decoding results in the M processes based on the decoding result fed back by the terminal device and the first configuration information comprises:
receive an acknowledgment (ACK) or a negative acknowledgment (NACK) on the i^{th} feedback resource, wherein the ACK or the NACK is determined based on the decoding results in the Mᵢ processes; and
determine the decoding results in the M processes based on the i^{th} feedback resource and the ACK or the NACK.

20. The apparatus according to claim 14, wherein the first configuration information comprises a bitmap, each bit in the bitmap corresponds to one process in the N processes, and a value of the bit indicates whether the terminal device is to feed back a decoding result in the corresponding process in the N processes.
